(19) United States
(12) Patent Application Publication
(10) Pub. No.: US 2025/0386352 A1
(43) Pub. Date: Dec. 18, 2025

(54) APPARATUS AND METHOD FOR REDUCING PADDING IN DUAL CONNECTIVITY

(71) Applicant: Samsung Electronics Co., Ltd., Suwon-si (KR)

(72) Inventors: Ankur POONIYA, Bangalore (IN); Arijit SEN, Bangalore (IN); Arvind RAMAMURTHY, Bangalore (IN); Koustav ROY, Bangalore (IN)

(21) Appl. No.: 19/316,279

(22) Filed: Sep. 2, 2025

Related U.S. Application Data
(63) Continuation of application No. PCT/KR2024/005332, filed on Apr. 19, 2024.

(30) Foreign Application Priority Data
Mar. 21, 2024 (IN) 2023 41031444
May 3, 2023 (IN) 202341031444

(51) Int. Cl. H04W 72/21; H04W 28/02

(52) U.S. Cl. CPC H04W 72/21; H04W 28/0278

(57) ABSTRACT

A method for optimizing a medium access control (MAC) padding and uplink (UL) grants in a wireless network is provided. The method includes transmitting buffer status report (BSR) to a network apparatus from at least one of a first MAC entity or a second MAC entity, receiving UL grants from the network apparatus based on a data volume requested in the BSR, transmitting UL transmission data from one of the first MAC entity or the second MAC entity to the network apparatus by MAC padding the UL transmission data based on the UL grants and the data volume, determining a set of padded bits of the UL transmission data one of the first MAC entity or the second MAC entity, and scaling the data volume to a scaled data volume be requested in a subsequent BSR at the at least one of the first MAC entity or the second MAC entity.

### CROSS-REFERENCE TO RELATED APPLICATION(S)

This application is a continuation application, claiming priority under 35 U.S.C. § 365(c), of an International application No. PCT/KR2024/005332, filed on April 19, 2024, which is based on and claims the benefit of an Indian Provisional application number 202341031444, filed on May 3, 2023, in the Indian Patent Office, and of an Indian Complete patent application number 202341031444, filed on March 21, 2024, in the Indian Patent Office, the disclosure of each of which is incorporated by reference herein in its entirety.

### BACKGROUND

### Field

The disclosure relates to the field of wireless communication network. More particularly, the disclosure relates to optimizing a medium access control (MAC) padding and uplink (UL) grants in a wireless network.

### Description of Related Art

In the context of 3rd generation partnership project (3GPP) specification TS 38.323, wherein a single packet data convergence protocol (PDCP) entity is associated with multiple radio link control (RLC) entities (such as multi-radio access technology dual connectivity (MRDC) E-UTRAN new radio dual connectivity (ENDC) new radio-dual connectivity (NRDC), among others), a user equipment (UE) may report the same or duplicated buffer status reporting (BSR) over both medium access control (MAC) entities. This poses a challenge for the MAC scheduler entities on the network side, as they lack a mechanism for inter-communication, or may add high backhaul delay during throughput sessions. Consequently, both MAC scheduler entities may provide high uplink grants to the UE, resulting in the UE receiving higher grants than required. To compensate for this, the UE may send a MAC padding for extra grants, leading to an increase in power consumption on the UE side and wastage of the network side resources in receiving the padding data.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for optimizing medium access control (MAC) padding and uplink (UL) grants in a wireless network.

Another aspect of the disclosure is to reduce resource wastage in the MAC padding and to avoid/reduce unnecessary uplink transmissions due to the issue of duplicate buffer status report (BSR) reporting resulting in excessive grant allocation by the network.

Another aspect of the disclosure is to detect and dynamically scale down the MAC padding through continuous monitoring of UL transmissions from the UE, resulting in a reduction of the data volumes requested in the BSR report sent to the network.

Another aspect of the disclosure is to monitor data received from the UE, detect the MAC padding, and dynamically scale it down. This is achieved by reducing the uplink grant allocation by the network.

Another aspect of the disclosure is to ascertain the delta factor, which specifies the reduction in the BSR by the UE or grant allocations by the networks upon detection of the MAC padding issue. The delta factor may be determined through employment of an machine learning (ML) model or a sliding window mechanism.

Additional aspects will be set forth in part in the description which follows and, in part, will be apparent from the description, or may be learned by practice of the presented embodiments.

In accordance with an aspect of the disclosure, a method performed by a user equipment (UE) in a wireless network system is provided. The method includes transmitting, to a first network node, a first BSR, the first BSR including a first data volume for transmission of a packet data convergence protocol (PDCP) entity, transmitting, to a second network node, a second BSR, the second BSR including a second data volume for transmission of the PDCP entity, transmitting, to the first network node, first UL transmission data with a first set of padded bits, based on first UL grants from the first network node, transmitting, to the second network node, second UL transmission data with a second set of padding bits, based on second UL grants from the second network node, scaling the first data volume to a first scaled data volume to be requested in a first subsequent BSR to the first network node, based on a first MAC padding ratio of the first set of padded bits of the first UL transmission data over a first UL throughput to the first network node, and scaling the second data volume to a second scaled data volume to be requested in a second subsequent BSR to the second network node, based on a second MAC padding ratio of the second set of padded bits of the second UL transmission data over a second UL throughput to the second network node.

In accordance with another aspect of the disclosure, a method performed by a network node in a wireless network system is provided. The method includes receiving, from a UE, a BSR, the BSR including a data volume for transmission of a PDCP entity for split bearer, transmitting, to the UE, UL grants, based on the data volume requested in the BSR, receiving, from the UE, UL transmission data with a set of padding bits in accordance with the UL grants, and scaling the UL grants to scaled UL grants to be provided to the UE, based on a MAC padding ratio of the set of padded bits of the UL transmission data over an UL throughput from the UE to the network node.

In accordance with another aspect of the disclosure, a UE in a wireless network system is provided. The UE includes at least one transceiver, at least one processor, and memory storing instructions that, when executed by the at least one processor individually or collectively, cause the UE to transmit, to a first network node through the at least one transceiver, a BSR, the first BSR including a first data volume for transmission of a PDCP entity, transmit, to a second network node through the at least one transceiver, a second BSR, the second BSR including a second data volume for transmission of the PDCP entity, transmit, to the first network node through the at least one transceiver, first UL transmission data with a first set of padded bits, based on first UL grants from the first network node, transmit, to the second network node through the at least one transceiver, second UL transmission data with a second set of padding bits, based on second UL grants from the second network node, scale the first data volume to a first scaled data volume to be requested in a first subsequent BSR to the first network node, based on a first MAC padding ratio of the first set of padded bits of the first UL transmission data over a first UL throughput to the first network node, and scale the second data volume to a second scaled data volume to be requested in a second subsequent BSR to the second network node, based on a second MAC padding ratio of the second set of padded bits of the second UL transmission data over a second UL throughput to the second network node.

In accordance with another aspect of the disclosure, a network node in a wireless network system is provided. The network node includes at least one transceiver, at least one processor, and memory storing instructions that, when executed by the at least one processor individually or collectively, cause the network node to receive, from a UE through the at least one transceiver, a BSR, the BSR including a data volume for transmission of a PDCP entity for split bearer, transmit, to the UE through the at least one transceiver, UL grants based on the data volume requested in the BSR, receive, from the UE through the at least one transceiver, UL transmission data with a set of padding bits in accordance with the UL grants, and scale the UL grants to scaled UL grants to be provided to the UE, based on a MAC padding ratio of the set of padded bits of the UL transmission data over an UL throughput from the UE to the network node.

In accordance with another aspect of the disclosure, a method for optimizing MAC padding and UL grants in a wireless network is provided. The method includes transmitting, by a UE, a BSR to a network apparatus from at least one of a first MAC entity and a second MAC entity. The BSR includes a data volume for transmission of an PDCP entity. Further, the method includes receiving, by the UE, UL grants from the network apparatus based on the data volume requested in the BSR. Thereafter, the method includes transmitting, by the UE, the UL transmission data from at least one of the first MAC entity and the second MAC entity to the network apparatus by MAC padding the UL transmission data based on the UL grants and the data volume. Furthermore, the method includes determining, by the UE, a set of padded bits of the UL transmission data at the at least one of the first MAC entity and the second MAC entity. Further, the method includes scaling, by the UE, the data volume to be requested in the subsequent BSR at the at least one of the first MAC entity and the second MAC entity to optimize the UL grants from the network apparatus and the MAC padding at the UE.

In an embodiment, the method to transmit, the BSR to the network apparatus from at least one of the first MAC entity and the second MAC entity includes transmitting by the UE the scaled data volume from at least one of the first MAC entity and the second MAC entity to the network apparatus, wherein the subsequent BSR comprises the scaled data volume .Moreover, the method includes receiving, by the UE, UL grant from the network apparatus based on the scaled data volume requested in the subsequent BSR .Furthermore, the method includes transmitting, by the UE, the UL transmission data from at least one of the first MAC entity and the second MAC entity to the network apparatus by MAC padding the set of data bits of the UL transmission data based on the UL grants and the scaled data volume.

In an embodiment, the PDCP entity is simultaneously associated with at least one the first MAC entity and the second MAC entity for a radio bearer.

In an embodiment, the method to scale at least one of the first MAC entity and the second MAC entity of the UE, the data volume to be requested in the subsequent BSR to optimize the UL grants from the network apparatus and the MAC padding at the UE includes determining, by the UE, a MAC padding ratio based on the set of padded bits of the UL transmission data and a throughput data from a physical layer of the UE. Moreover, the method includes determining, by the UE, whether the MAC padding ratio meets the MAC padding high criteria or the MAC padding low criteria and the UE meets a throttled criterion. Further, the method includes, by the UE, down- scaling the data volume to be requested in the subsequent BSR that optimizes the UL grants from the network apparatus and the MAC padding at the UE, when the MAC padding ratio meets the MAC padding high criteria and the UE does not meet the throttled criteria. Also, the method includes, by the UE, up-scaling the data volume to be requested in the subsequent BSR that optimizes the UL grants from the network apparatus and the MAC padding at the UE, when the MAC padding ratio meets the MAC padding low criteria and the UE meets the throttled criteria.

In an embodiment, the throttled criteria indicate a state in which the first MAC entity and the second MAC entity of the UE has reduced a level of the BSR reporting meeting a predefined BSR reporting threshold.

In an embodiment, up-scaling the data volume to be requested in thesubsequent BSR includes determining an up-scaling factor by which the UL grants from the network apparatus and the MAC padding at the UE has to be optimized based on a plurality of parameters using a ML model. Moreover, the method includes up-scaling the data volume to be requested in the subsequent BSR by the up-scaling factor.

In an embodiment, the method to determine the up-scaling factor, by the UE includes, inputting, by the UE, the plurality of parameters into the ML model, wherein the plurality of parameters comprises the BSR comprises a data volume for transmission of the PDCP entity, set of padded bits of the UL transmission data, network signal conditions, a MAC padding pattern used by the UE, an up-scaling factor pattern, a reported BSR index over each legs, a current PDCP status, a current RLC buffer status, a current network load associated with the first MAC entity and the second MAC entity, a bandwidth over each channels associated with the network apparatus, and a number of carrier components for each uplink channels to decide. Moreover, the method includes, obtaining, by the UE, the up-scaling factor by which the UL grants from the network apparatus and the MAC padding at the UE has to be optimized as an output from the ML mode.

In an embodiment, the method to down-scale the data volume to be requested in the subsequent BSR by the UE, includes determining a down-scaling factor by which the UL grants from the network apparatus and the MAC padding at the UE has to be optimized based on the plurality of parameters. Moreover, the method includes down-scaling the data volume to be requested in the subsequent BSR by the down- scaling factor.

In an embodiment, the method includes determining the down-scaling factor includes determining, by the UE the down-scaling factor by which the UL grants from the network apparatus and the MAC padding at the UE has to be optimized based on the plurality of parameter. Moreover, the method includes down-scaling the data volume to be requested in the subsequent BSR by the down-scaling factor.

In an embodiment, the method includes determining the down-scaling factor includes inputting, by the UE, the plurality of parameters into the ML model, wherein the plurality of parameters comprises the BSR comprises a data volume for transmission of the PDCP entity, set of padded bits of the UL transmission data, network signal conditions, the MAC padding pattern used by the UE, the down-scaling factor pattern, the reported BSR index over each legs, the current PDCP status, the current RLC buffer status, the current network load associated with the first MAC entity and the second MAC entity, the bandwidth over each channels associated with the network apparatus, and the number of carrier components for each uplink channels to decide .Moreover, the method includes obtaining, by the UE, the down-scaling factor by which the UL grants from the network apparatus and the MAC padding at the UE has to be optimized as an output from the ML model.

In accordance with another aspect of the disclosure, a method foroptimizing the MAC padding and UL grants in the wireless networks is provided. The method includes receiving, by the network apparatus, the BSR by the UE from at least one the first MAC entity and the second MAC entity, wherein the BSR includes a data volume for transmission of the PDCP entity. Further, the method includes transmitting, by the network apparatus, UL grants to the UE based on the data volume requested in the BSR. Thereafter, the method includes receiving by the network apparatus, the UL transmission data from at least one of the first MAC entity or the second MAC entity of the UE by MAC padding the UL transmission data based on the UL grants and the data volume. Furthermore, the method includes determining, by the UE, the set of padded bits of the UL transmission data at the at least one of the first MAC entity or the second MAC entity. Further, the method includes scaling, by the network apparatus, the UL grants to optimize the MAC padding received in subsequent UL transmissions from the first MAC entity and the second MAC entity of the UE.

In an embodiment, the method to scale, by at least one of the first MACentity or the second MAC entity of the UE, the UL grants allocated to the UE to optimize the MAC padding at the UE includes determining, by the network apparatus, the MAC padding ratio based on the set of padded bits of the UL transmission data and a throughput data from a physical layer of the UE. Moreover, the method includes determining, by the network apparatus, whether the MAC padding ratio meets the MAC padding high criteria or the MAC padding low criteria and the UE meets the throttled criterion. Further, the method includes down-scaling the UL grants to optimize the data volume and the MAC padding received in the subsequent UL transmissions from the first MAC entity and the second MAC entity of the UE, when the MAC padding ratio meets the MAC padding high criteria and the network apparatus does meet the throttled criteria. Also, the method includes up-scaling the UL grants to optimize the MAC padding received in the subsequent UL transmissions from the first MAC entity and the second MAC entity of the UE, when the MAC padding ratio meets the MAC padding low criteria and the network apparatus meets the throttled criteria.

In an embodiment, the throttled criteria indicate a state in which the network apparatus has reduced a level of UL grant meeting a predefined UL grant threshold.

In an embodiment, the method to up-scale the UL grant allocation to the UE includes determining the up-scaling factor by which the UL grants from the network apparatus has to be optimized based on the plurality of parameters using the ML model. Moreover, the method includes up-scaling the UL grants by the up-scaling factor includes

In an embodiment, the method to up-scale factor includes inputting, by the network apparatus, the plurality of parameters into the ML model, wherein the plurality of parameters includes the BSR which comprises a data volume for transmission of the PDCP entity, set of padded bits of the UL transmission data, network signal conditions, the MAC padding pattern used by the UE, the up-scaling factor pattern, the reported BSR index over each legs, the current PDCP status, the current RLC buffer status, the current network load associated with the first MAC entity and the second MAC entity, the bandwidth over each channels associated with the network apparatus, and the number of carrier components for each uplink channels to decide. Moreover, the method includes obtaining, by the network apparatus, the up-scaling factor by which the UL grants from the network apparatus has to be optimized as an output from the ML mode.

In an embodiment, the method to down-scaling UL grant allocation to the UE includes determining the down-scaling factor by which the UL grants from the network apparatus has to be optimized based on the plurality of parameters. Moreover, the method includes down-scaling the UL grants by the down-scaling factor.

In an embodiment, the method includes determining the down-scaling factor includes inputting by the network apparatus the plurality of parameters into the ML model. Further, the plurality of parameters includes the BSR which comprises the data volume for transmission of the PDCP entity, set of padded bits of the UL transmission data, network signal conditions, the MAC padding sent by the UE, the down-scaling factor pattern, the reported BSR index over each legs, the current PDCP status, the current RLC buffer status, the current network load associated with the first MAC entity and the second MAC entity, the bandwidth over each channels associated with the network apparatus, and the number of carrier components for each uplink channels to decide. Moreover, the method includes obtaining, by the network apparatus, the down-scaling factor by which the UL grants from the network apparatus has to be optimized as the output from the ML model.

In accordance with another aspect of the disclosure, an UE for optimizing the MAC padding and UL grants in the wireless network system is provided. The UE includes memory including information about the network apparatus and the plurality of entities comprising the first MAC entity, the second MAC entity, the PDCP entity and the processor communicatively coupled to the memory and a MAC padding optimization controller. The MAC padding optimization controller is configured to transmit the BSR to the network apparatus from at least one of the first MAC entity or the second MAC entity, wherein the BSR comprises a data volume for transmission of the PDCP entity. Further the MAC padding optimization controller is configured to receive UL grants from the network apparatus based on the data volume requested in the BSR. Thereafter, the MAC padding optimization controller is configured to transmit the UL transmission data from at least one of the first MAC entity or the second MAC entity to the network apparatus by MAC padding the UL transmission data based on the UL grants and the data volume. Furthermore, the MAC padding optimization controller is configured to determine the set of padded bits of the UL transmission data at the at least one of the first MAC entity or the second MAC entity. Moreover, the MAC padding optimization controller is configured to scale the data volume to be requested in the subsequent BSR at the at least one of the first MAC entity or the second MAC entity to optimize the UL grants from the network apparatus and the MAC padding at the UE.

In an embodiment, the throttled criteria indicate a state in which the first MAC entity and the second MAC entity of the UE has reduced a level of the BSR reporting meeting the predefined BSR reporting threshold.

In accordance with another aspect of the disclosure, a network apparatus for optimizing the MAC padding and UL grants in the wireless network system is provided. The network apparatus includes the memory comprising information about the UE and the plurality of entities comprising the first MAC entity, the second MAC entity and the processor communicatively coupled to the memory and a UL grant optimization controller. The UL grant optimization controller is configured to receive the BSR by the UE from at least one the first MAC entity and the second MAC entity. The BSR includes a data volume for transmission of the PDCP entity. Further the UL grant optimization controller is configured to transmit UL grants to the UE based on the data volume requested in the BSR. Thereafter, the UL grant optimization controller is configured to receive the UL transmission data from at least one of the first MAC entity or the second MAC entity of the UE by MAC padding the UL transmission data based on the UL grants and the data volume. Furthermore, the UL grant optimization controller is configured to determine the set of padded bits of the UL transmission data at the at least one of the first MAC entity or the second MAC entity. Moreover, UL grant optimization controller is configured to scale the UL grants to optimize the MAC padding received in subsequent UL transmissions from the first MAC entity and the second MAC entity of the UE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an uplink packet data convergence protocol (PDCP)aggregation in an E-UTRA-NR dual connectivity (ENDC)/NR-E-UTRA dual connectivity (NEDC), according to an embodiment of the disclosure;

FIG. 2 illustrates the uplink PDCP aggregation in a new-radio-new radiodual connectivity (NR-NR DC), according to an embodiment of the disclosure;

FIG. 3 is a sequence diagram that illustrates the duplication of a buffer status report (BSR) by a user equipment (UE) on both MAC entities, according to an embodiment of the disclosure;

FIG. 4 illustrates a block diagram of the UE for optimizing medium access control (MAC) padding and uplink (UL) grants in a wireless network, according to an embodiment of the disclosure;

FIG. 5 illustrates a schematic view of a machine learning (ML) model on the UE side, according to an embodiment of the disclosure;

FIG. 6 is a flow diagram that illustrates a method for optimizing MAC padding at the UE, according to an embodiment of the disclosure;

FIG. 7 is a sequence diagram that illustrates operations performed to optimize grant allocation and bringing the MAC Padding minimal for efficient usage of UL resources, according to an embodiment of the disclosure;

FIG. 8 is a sequence diagram that illustrates the MAC Padding optimization approach, according to an embodiment of the disclosure;

FIG. 9 illustrates a block diagram of a network apparatus for optimizing the MAC padding and UL grants in the wireless network, according to an embodiment of the disclosure;

FIG. 10 is a schematic view of the ML model designed for a network side, according to an embodiment of the disclosure;

FIG. 11 is a flow diagram that illustrates a method for optimizing UL grants at the network apparatus, according to an embodiment of the disclosure;

FIG. 12 is a sequence diagram that illustrates network's operations for scheduling uplink grants, according to an embodiment of the disclosure;

FIG. 13 is a sequence diagram that illustrates the signaling flow of the MAC entities and a New Radio (NR) grant scheduling in the ENDC scenario, according to an embodiment of the disclosure;

FIG. 14 is a sequence diagram that illustrates operations performed by the UE for sending the BSR report, according to an embodiment of the disclosure; and

FIG. 15 is a flow chart that illustrates a method for optimizing the MAC padding and UL grants in the wireless network system, according to an embodiment of the disclosure.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well- known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms "a," "an," and "the" include plural referents unless the context clearly dictates otherwise. Thus, for example, reference to "a component surface" includes reference to one or more of such surfaces.

In various examples of the disclosure described below, a hardware approach will be described as an example. However, since various example embodiments include a technology that utilizes both the hardware-based and the software-based approaches, they are not intended to exclude the software-based approach.

As used in the following description, the terms referring to signals (e.g., signal, information, message, signaling), the terms referring to resources (e.g., symbol, slot, subframe, radio frame, subcarrier, resource element (RE), resource block (RB), bandwidth part (BWP), occasion), the terms referring to the state for resources (enable,disable, activation, deactivation, available, unavailable, facilitate, applicable, accessible), the terms for indicating operating states (e.g., step, operation, procedure), the terms referring to data (e.g., packet, user stream, information, bit, symbol, codeword), the terms referring to channels, the terms referring to network entities, the terms referring to components of an apparatus, and so on are illustrated for convenience of description. Therefore, the disclosure is not limited to those terms described below, and other terms having equivalent technical meanings may be used therefor.

Further, throughout the disclosure, an expression such as e.g., 'above' or 'below' may be used to determine whether a specific condition is satisfied or fulfilled, but it is merely of a description for expressing an example and is not intended to exclude the meaning of 'more than or equal to' or 'less than or equal to'. A condition described as 'more than or equal to' may be replaced with 'above', a condition described as 'less than or equal to' may be replaced with 'below', and a condition described as 'more than or equal to' and 'below' may be replaced with 'above' and 'less than or equal to', respectively. In addition, unless explicitly dictated otherwise, 'A' to 'B' is intended to mean at least one of the elements from A to (inclusive of A) and B (inclusive of B).

Further, the disclosure describes various embodiments using terms used in some communication specifications (e.g., 3rd generation partnership project (3GPP), extensible radio access network (xRAN), and open-radio access network (0-RAN)), but it is merely an example for description. Various embodiments of the disclosure may be easily modified and applied even in other communication systems.

Throughout the disclosure, the measurement signal may refer to a signal measured by a terminal in order to obtain the signal quality for use in mobility, admission control, or radio resource management (RRM). For example, the measurement signal may at least one of synchronization signal (e.g., SS block), beam reference signal (BRS), beam refinement reference signal (BRRS), cell-specific reference signal (CRS), channel status information-reference signal (CSI-RS), or demodulation-reference signal (DM-RS). According to embodiments, the base station may not only transmit one type of measurement signal, but also transmit a measurement signal of each of two or more types.

The signal quality may refer to at least one of, for example, reference signal received power (RSRP), beam reference signal received power (BRSRP), reference signal received quality (RSRQ), received signal strength indicator (RSSI), signal to interference and noise ratio (SINR), carrier to interference and noise ratio (CINR), signal to noise ratio (SNR), error vector magnitude (EVM), bit error rate (BER), or block error rate (BLER). In addition to the above-described examples, it will be apparently understood that other terms having equivalent technical meanings or other metrics indicating channel quality may be used. Hereinafter, the term 'high signal quality' used in the disclosure may refer to an occasion that a signal quality value related to a signal size is relatively larger or a signal quality value related to an error rate is relatively smaller.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by the processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments disclose a method for optimizing medium access control (MAC) padding and UL grants in a wireless network system. The method includes transmitting, by a user equipment (UE), a buffer status report (BSR) to a network apparatus from at least one of a first MAC entity or a second MAC entity. In case of dual connectivity (DC) being configured to the UE, the UE is configured with two MAC entities. Hereinafter, the two MAC entities correspond to the first MAC entity and the second MAC entity. The BSR comprises a data volume for transmission of a packet data convergence protocol (PDCP) entity. Further, the method includes receiving, by the UE, UL grants from the network apparatus based on the data volume requested in the BSR. Thereafter, the method includes transmitting, by the UE, the UL transmission data from at least one of the first MAC entity or the second MAC entity to the network apparatus by MAC padding the UL transmission data based on the UL grants and the data. Furthermore, the method includes determining, by the UE, a set of padded bits of the UL transmission data at the at least one of the first MAC entity or the second MAC entity. Further, the method includes scaling, by the UE, the data volume to be requested in the subsequent BSR at the at least one of the first MAC entity or the second MAC entity to optimize the UL grants from the network apparatus and the MAC padding at the UE.

Accordingly, the embodiment herein is to provide the method for optimizing the MAC padding and UL grants in the wireless networks. The method includes, receiving, by the network apparatus, the BSR by the UE from one of the entities, wherein the BSR comprises the data volume for transmission of the PDCP entity. Further, the method includes transmitting, by the network apparatus, UL grants to the UE based on the data volume requested in the BSR. Thereafter, the method includes receiving by the network apparatus, the UL transmission data from at least one of the first MAC entity or the second MAC entity of the UE by the MAC padding the UL transmission data based on the UL grants and the data volume. Furthermore, the method includes determining, by the UE, the set of padded bits of the UL transmission data at one of the entities. Further, the method includes scaling, by the network apparatus, the UL grants to optimize the MAC padding received in subsequent UL transmissions from the entities.

Accordingly, the embodiment herein is to provide the UE for optimizing the MAC padding and UL grants in the wireless network system, The UE comprises memory comprising information about the network apparatus and a MAC entity comprising the first MAC entity, the second MAC entity an I/O interface, a processor and a MAC padding optimization controller. The MAC padding optimization controller is configured to transmit the BSR to the network apparatus from at least one of the first MAC entity or the second MAC entity wherein the BSR comprises a data volume for transmission of the PDCP entity. Further the MAC padding optimization controller is configured to receive UL grants from the network apparatus based on the data volume requested in the BSR. Thereafter, the MAC padding optimization controller is configured to transmit the UL transmission data from at least one of the first MAC entity or the second MAC entity to the network apparatus by MAC padding the UL transmission data based on the UL grants and the data volume. Furthermore, the MAC padding optimization controller is configured to determine the set of padded bits of the UL transmission data at one of the entities. Moreover, the MAC padding optimization controller is configured to scale the data volume to be requested in the subsequent BSR at the at one of the entities to optimize the UL grants from the network apparatus and the MAC padding at the UE.

Accordingly, the embodiment herein is to provide the network apparatus for optimizing the MAC padding and UL grants in the wireless network system. The network apparatus comprises the memory comprising information about the UE and the MAC entity comprising the first MAC entity, the second MAC entity and the processor communicatively coupled to the memory and a UL grant optimization controller. The UL grant optimization controller is configured to receive the BSR by the UE from the entities. The BSR comprises a data volume for transmission of the PDCP entity. Further the UL grant optimization controller is configured to transmit UL grants to the UE based on the data volume requested in the BSR. Thereafter, the UL grant optimization controller is configured to receive the UL transmission data from at least one of the first MAC entity or the second MAC entity of the UE by the MAC padding the UL transmission data based on the UL grants and the data volume. Furthermore, the UL grant optimization controller is configured to determine a set of padded bits of the UL transmission data at the entities. Moreover, UL grant optimization controller is configured to scale the UL grants to optimize the MAC padding received in subsequent UL transmissions from the entities.

In the current scenario, when the BSR report is received from the UE, the MAC scheduler entities (hereinafter, MAC entities) on the network side lack a mechanism to communicate with each other for coordinated resource assignment. Because, in DC, each network side (e.g., master node (MN), secondary node (SN) has own scheduler. Thus, the UE is configured with a first MAC entity for MN and a second MAC entity for SN. This can lead to delays in UL resource allocation during high throughput sessions, potentially reducing the overall throughput. Furthermore, since most network operators use different Random-access network (RAN) vendors for LTE (Long term evolution) and NR, the absence of a common communication protocol between the schedulers makes orchestration impossible. Consequently, the schedulers allocate resources on both legs for the UE, resulting in higher grants than required. The UE then utilizes what it needs and pads the remaining grant with a stream of 0's, leading to high MAC padding. This padding is a waste of the UE's Tx power, network processing power, and UL resources. Moreover, if thousands of devices are connected to the RAN, the wastage of resources in the MAC padding becomes a major issue.

The proposed solution provides a method for optimizing the MAC padding and UL grants in the wireless network system. This idea describes a System and method to avoid/reduce unnecessary uplink transmissions due to the issue of duplicate BSR reporting resulting in excessive grant allocation by the network. The solution includes identification and quantification, expressed in percentage, of the MAC padding transmitted by the UE in uplink. By comparing the BSR requested by the UE to the grant allocated, a ML model can recommend the reduction factor by which the BSR request or grant allocations should be scaled down. Subsequently, the UE and the network adjusts their BSR and UL grant allocations, respectively, until the padding falls within an acceptable threshold. If the padding values drop below the set threshold, the UE will gradually ease the scale down factor.

Dual connectivity refers to a technology in which a user equipment (UE) (e.g., mobile handset) is simultaneously connected, directly or indirectly, with two or more independent heterogeneous and/or homogeneous wireless communication cell groups having a separate radio resource control entity. As the radio resource control entity, the term 'base station' may be used to describe embodiments. In addition to the term 'base station', the base station may be referred to as 'access point (AP)', 'eNodeB (or eNB)', '5th generation node (5G node)', '5G nodeB (NB)', 'next generation node B (gNB)', 'radio access network (RAN) node, transmission/reception point (TRP), network apparatus, central unit (CU), control unit (CU), distributed unit (DU), radio unit (RU), remote radio head (RRH), or other terms with equivalent technical meanings thereto. According to an embodiment, the base station may be connected, directly or indirectly, to one or more transmission/reception points (TRPs). The base station may transmit a downlink signal or receive an uplink signal to/from the UE through one or more TRPs. The UE, which is a device used by a user, may communicate with the base station or two base stations over a wireless channel. In addition to term 'UE', the UE may be referred to as 'terminal', 'mobile station', 'subscriber station', 'customer premises equipment (CPE)', 'remote terminal', 'wireless terminal', 'electronic device', or 'vehicle terminal', 'user device', or any other terms having equivalent technical meaning thereto.

The UE according to embodiments may be configured in a dual connectivity (DC) using both the first base station and the second base station. The dual connectivity refers to a technology in which a terminal may be connected, directly or indirectly, to two different radio resource entities to use radio resources allocated by each of the radio resource entities. In MR-DC, a UE (e.g., the UE, which may be a mobile handset for example) in an RRC connected state (e.g., RRC_CONNCETED) may be configured to use radio resources provided by two independent schedulers, wherein each scheduler may be located at an NG-RAN node (e.g., the first base station and the second base station). Here, one node is a master node (MN) and the other node is a secondary node (SN). The MN and the SN may be connected through a network interface, and the MN may be connected to a core network. SN may or may not be connected, directly or indirectly, to the core network.

The MN may provide a master cell group (MCG). The MN may be referred to as an M-NODE or an M-NG-RAN node in addition to the MN. The MCG may include one or more cells. The MCG may include a primary cell (PCell). The MCG may include a plurality of aggregated cells. The MCG may include a PCell and one or more secondary cells (SCell). The SN may provide a secondary cell group (SCG). SN may be referred to as an S-NODE or an S-NG-RAN node in addition to SN. The SCG may include one or more cells. The SCG may include a plurality of aggregated. Like the MCG, the SCG may include a PCell and/or an SCell. A cell acting as a PCell in the SCG may be referred to as a primary secondary cell (PSCell). A sub-cell group may include a PSCell and one or more SCells. Hereinafter, a special cell (SpCell) may be used as a term including PCell and PSCell. The Spcell refers to a primary cell of an MCG or and SCG. In other words, the SpCell of the MCG may indicate the PCell, and the SpCell of the SCG may indicate the SCell.

Definition of possible types of DCs may be provided as follows.

EN-DC: A dual connection in which an eNB is connected, directly or indirectly, to an evolved packet core (EPC) and a terminal is connected, directly or indirectly, to an eNB acting as an MN and a gNB acting as an SN. Here, the gNB may be referred to as an en-gNB, and the en-gNB may or may not be connected to the EPC.

NGEN-DC: A dual connection in which an eNB is connected, directly or indirectly, to an evolved packet core (EPC) and a terminal is connected, directly or indirectly, to a 5G core (5GC) and a terminal is connected, directly or indirectly, to an eNB acting as an MN and a gNB acting as an SN. Here, the eNB may be referred to as an ng-eNB.

NE-DC: A dual connection in which a gNB is connected, directly or indirectly, to 5GC and a terminal is connected, directly or indirectly, to a gNB operating as an MN and an eNB operating as an SN. Here, the eNB may be referred to as an ng- eNB.

NR-DC: A dual connectivity in which gNBs are connected, directly or indirectly, to 5GC and a terminal is connected to a gNB acting as an MN and a gNB acting as an SN. NR-DC may also be used when the UE is connected, directly or indirectly, to a (e.g., single) gNB to perform the role of both the MN and the SN and configure both the MCG and the SCG.

The UE may support multi-radio (MR)-DC. The UE may be connected, directly or indirectly, to the first base station and the second base station. The first base station may be an MN, and the second base station may be an SN, so that they may be connected to the terminal. Along with carrier aggregation (CA) provided by each base station, the dual connection may provide a higher data rate. The first base station and the second base station may transmit downlink traffic to The UE or receive uplink traffic from the UE, as an MN and an SN, respectively.

The UE may be located within a cell coverage of the first base station. The UE may be located within a cell coverage of the second base station. In a split bearer, downlink transmission may be performed through a PCell and a PSCell. The split bearer may refer to a radio bearer with an RLC bearer in both an MCG and an SCG in MR-DC. The UE may use the wireless network resources of the first base station and the second base station together, through the split bearer. According to an embodiment, the split bearer may be of an MN-terminated bearer. The MN-terminated bearer may refer to a bearer in which a packet data convergence protocol (PDCP) is in the MN. The split bearer may be of an SN-terminated bearer. The SN-terminated bearer refers to a bearer in which PDCP is in SN.

The uplink transmission of The UE may be performed through at least one of the PCell or the PSCell. The UE may determine whether to transmit uplink data to one of the first base station and the second base station or whether to transmit uplink data to the first base station and the second base station through splitting, based on a size of the uplink data. In this case, it is required to set an uplink primary path used in both the situations. For example, a channel status for uplink transmission at a cell edge may not be good. For example, The UE may be located at a cell edge of the PSCell. That is, a plurality of terminals may make access to the second base station. In such an occasion, it is required to find a UL primary path of the UE.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

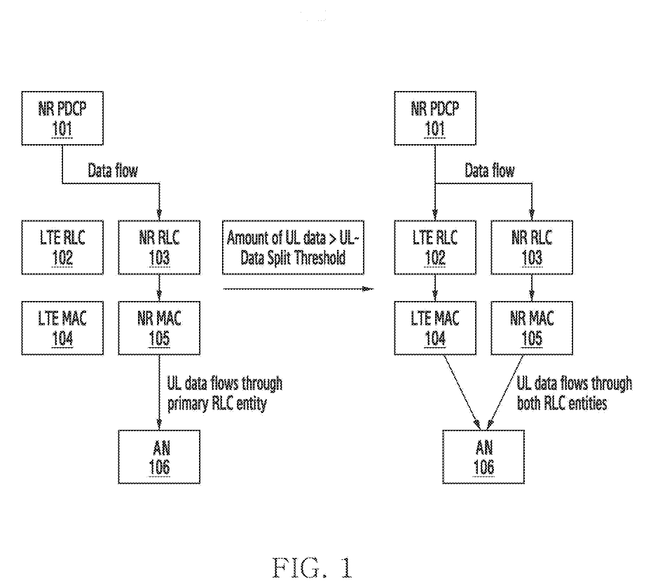

FIG. 1 illustrates an uplink PDCP aggregation in an E-UTRA-NR dual connectivity (ENDC)/NR-E-UTRA dual connectivity (NEDC), according to an embodiment of the disclosure.

NR PDCP (101) ensures efficient packet delivery by performing functions uch as header compression, ciphering, and integrity protection. The PDCP operates between RLC and radio resource control (RRC) layers, providing optimization and reliability for data transmission over the network.

In this scenario, data flows from the NR PDCP (101) to a first leg NR RLC (103), which is primary RLC entity, and then to a NR MAC (105) and finally, the UE (401) transmits UL data to an evolved node B (eNB) or next generation node B (gNB) through an access network (106). However, if the amount of UL data exceeds the UL data split threshold, data flows from both LTE RLC (102) and NR MAC (105) towards the access network (106). For example, in case of EN-DC, the data flow from LTE MAC (104) towards the eNB and the data flow from NR MAC (105) towards the gNB.

In the context of 5th generation (5G) new radio (NR) technology, the NR MAC (105) is a component of significance in the protocol stack responsible for managing access to the shared radio resource, and establishes UL data flow through primary RLC entity to access network (106). LTE MAC (104) layer is a component of significance in the LTE protocol stack. The 3GPP specification for MAC is referred as TS 36.321. It is responsible for managing the access to the shared radio resources and providing an efficient and fair allocation of these resources among multiple users in the wireless network.

In the context of mobile communications, a "split bearer" refers to a network configuration where the uplink data traffic is split between different legs LTE RLC (102), NR RLC (103) or paths to improve efficiency and performance. To control this split, the network sets a threshold for the amount of UL data that can be transmitted through a particular leg. This threshold is configured through the RRC reconfiguration message. The split bearer may provide a high degree of freedom for downlink transmission and uplink transmission. For the split bearer, the gNB may independently configure downlink transmission and uplink transmission. For example, in the split bearer, the UE (401) may receive DL traffic through both the MN radio spectrum and the SN radio spectrum and may transmit the UL traffic only in either one of the MN and the SN. As another example, in the split bearer, the UE (401) may receive DL traffic through both the MN radio spectrum and the SN radio spectrum, transmit the split UL traffic to either one of the MN and the SN, and transmit another split UL traffic to the other one of the MN and the SN. The threshold value (e.g., ul-DataSplitThreshold of 3GPP TS 38.331, configured by radio resource control (RRC) signaling) set for the UE (401) may be used to determine whether to split. In other words, once the UL data traffic exceeds the set threshold, the UE (401) can transmit the data through either a MCG or SCG legs, or both. In this scenario, the NR RLC (103) is designated as the primary leg, and the UE (401) will transmit the data through both the NR RLC (103) and LTE RLC (102) legs. This approach allows for use of available network resources and can improve the overall performance of the mobile network.

In case of configuration of the split bearer network in the ENDC setup, the network will configure a parameter called 'ul-DataSplitThreshold' in the reconfiguration. This parameter is used to define a threshold value for the total amount of UL data pending transmission.

When the total amount of UL data pending transmission crosses this threshold, the UE (401) will send UL data on either the MCG or SCG or split the data volume by a percentage across both the legs. This means that the UE (401) will either send all the data on one leg or split it between the two legs based on the threshold value.

In FIG. 1, the NR RLC (103) is shown as the primary leg, which means that it is the primary route for data transmission. Once the amount of pending UL data reaches a certain threshold known as the "ul-DataSplitThreshold," the UE (401) will split the data between both the NR and LTE RLC legs (103) (102).

If the total amount of the PDCP data volume and the RLC data volume pending for initial transmission in the two associated RLC entities is equal to or larger than the ul-DataSplitThreshold, the UE (401) will submit a PDCP protocol data unit (PDU) to either the primary RLC entity or the secondary RLC entity. However, if the total amount of pending data is less than the ul-DataSplitThreshold, the UE (401) will submit the PDCP PDU to the primary RLC entity.

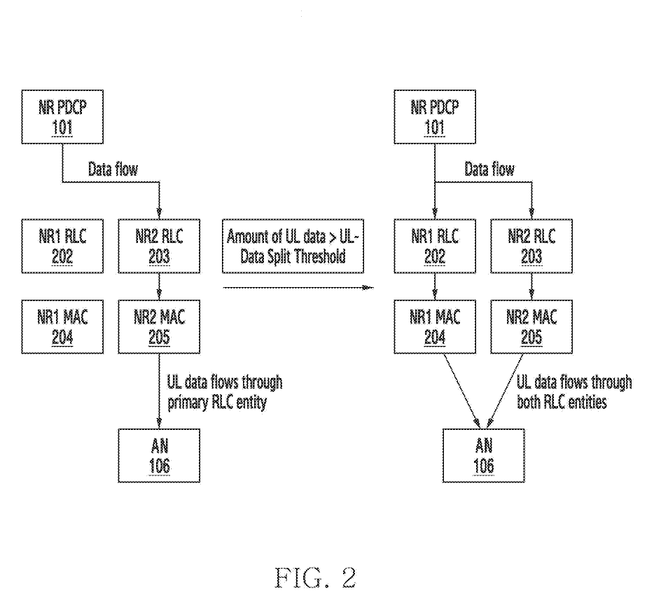

FIG. 2 illustrates the uplink PDCP aggregation in the NR-NR DC, according to an embodiment of the disclosure.

A second scenario of the split bearer, the network configures the UL-data split threshold in the RRC reconfiguration. When amount of UL data crosses threshold UE (401) which sends the UL data on either MCG or SCG or both legs. NR2 RLC (203) is shown as the primary leg and once an amount of the UL data goes above UL-data split threshold, sends the data on both NR1 RLC (202) and NR2 RLC (203) legs.

In this scenario, NR1 RLC (202) binds with NR2 RLC (203) to transmit and receive data. The UL data flow is transmitted and received. At the access network (106), there is a network node (may be referred as RAN node) in a cellular network that provides connectivity between UE (401) and core network. The RAN node is the functional equivalent of a base station in a traditional cellular network. From the NR PDCP (101), data flows to the NR2 RLC (203) and then to the NR2 MAC (205). UL data flows through the primary RLC entity to the access network (106). For example, in case of EN-DC, the data flow from NR1 MAC (204) towards the gNB #1 and the data flow from NR2 MAC (205) towards the gNB #2.

In case of NR-NR dual connectivity UL data flows through both RLC entities.

A next generation-radio access network (NG-RAN) supports the NR-DC, in which the UE (401) is connected to two RAN nodes that one acts as a master node (MN) and another one acts as a secondary node (SN). In addition, the NR-DC is used when the UE (401) is connected to two gNB-distributed unit (gNB-Dus), one serving the MCG and the other serving the SCG, connected to the same next generation node base station-central unit (gNB-CU), acting both as the MN and as the SN. If the amount of UL data exceeds the UL-data split threshold, then data flows through both RLC entities, namely NR1 RLC (202) and NR2 RLC (203), passing to NR1 MAC (204), NR2 MAC (205), and finally, the UE (401) transmits the data to the access network (106). In aspect of the UE (401), the UE (401) is configured with two MAC entities including the first MAC entity (406a) for the MN and the second MAC entity (406b) for the SN. The UE (401) transmits UL data to the MN and UL data to the SN.

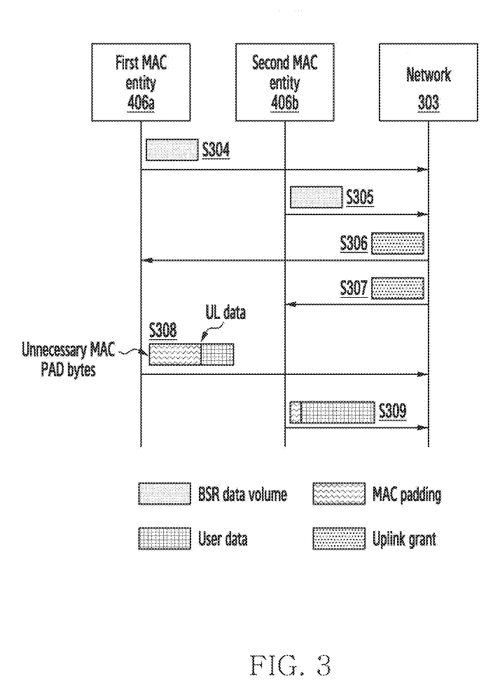

FIG. 3 is a sequence diagram that illustrates the duplication of the BSR by the UE (401) on both MAC entities (406a and 406b), according to an embodiment of the disclosure.

This highlights the issue of superfluous MAC padding-the MAC PAD bytes as disclosed herein. In an embodiment, the UE (401) duplicates the BSR on both the entities to indicate the PDCP data volume. The network allocates a grant on both entities. The UE (401) utilizes the grant on one leg and reserves the surplus grant on the other leg. In the disclosure, the device at the network (303) may be referred as the network node. In one implementation, the network node may be distributed unit (DU) connected to central unit (CU). In case of split bearer in dual connectivity (DC), two DUs are connected to the CU and the UE (401) can communicate with the two DUs. The CU and one DU acts MN and the CU and another DU acts SN. For example, for the first MAC entity, the UE (401) transmit the BSR to the DU acting as MN. For the second MAC entity, the UE (401) transmit the BSR to the other DU acting SN. For example, for the first MAC entity, the UE (401) receives UL grants from the DU acting as MN. For the second MAC entity, the UE (401) receives UL grants from the other DU acting SN. In another implementation, the network node may be RAN node corresponding to one base station. The network node may be eNB or gNB. In case of split bearer in dual connectivity (DC), two base stations are connected the UE (401). The two base station includes the MN and the SN. For example, for the first MAC entity, the UE (401) transmit the BSR to the MN. For the second MAC entity, the UE (401) transmit the BSR to the SN. For example, for the first MAC entity, the UE (401) receives UL grants from the MN. For the second MAC entity, the UE (401) receives UL grants from the SN. In one example, the UE (401) is configured with ENDC. The MN corresponds to eNB and the SN corresponds to gNB.

MAC entities (406) include First MAC entity (406a) and second MAC entity (406b).

At operations S304 and S305, the MAC entities' request for BSR (505) is transmitted to the network. At operation S304, the UE (401) transmits BSR to the network (303) (e.g., MN) through first MAC entity (406a). At operation S305, the UE (401) transmits BSR to the network (303) (e.g., SN) through second MAC entity (406b). At operations S306 and S307, the UE (401) receives uplink grants from the network. At operation S306, the UE (401) receives uplink grants from the MN. At operation S307, the UE (401) receives uplink grants from the SN. Further, at operation S308, the UE (401) transmits UL data associated with the first MAC entity (406a) and at operation S309, transmits UL data associated with the second MAC entity (406b). Network nodes at the network (303) receives the UL data from the first MAC entity (406a) and the second MAC entity (406b). For example, the MN receives UL data from the UE (401) and the SN receives UL data from the UE (401).

Duplication of the BSR (505) on both MAC entities (406) results in unnecessary consumption of UE (401) transmit power in transmitting MAC padding (506) that carries no useful information. Furthermore, it leads to wastage of network bandwidth and UL resources by allocating more than what the UE (401) requires. Additionally, it results in a waste of processing power on the network as it processes and subsequently ignores the padding.

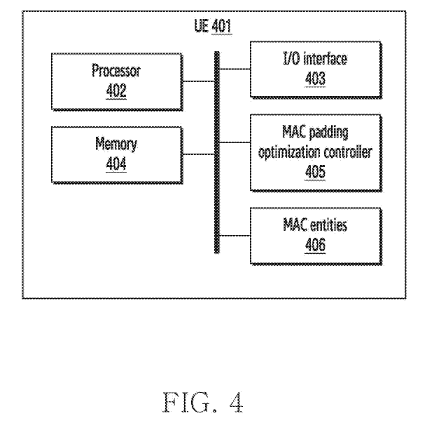

FIG. 4 illustrates a block diagram of the UE (401) for optimizing MAC padding (506) and UL grants in the wireless network, according to an embodiment of the disclosure.

The UE (401) includes the processor (402), memory (404), input/output (I/O) interface (403), MAC padding optimization controller (405) and MAC entities (406). The MAC entities (406) are responsible for managing access to the shared medium in a network, ensuring efficient transmission of data between devices. The UE (401) can be an end-user device that connects with a communication network to access services. For example, it can include electronic device, but not limited to a mobile phone, a smart phone, tablets, laptops, Internet of things (IoT) devices. Further, the processor (402) communicates with the memory (404), I/O interface (403), MAC padding optimization controller (405) and the MAC entities (406). The processor (402) is configured to execute instructions stored in the memory and to perform various processes. The processor (402) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

Further, the memory (404) of the UE (401) includes storage locations to be addressable through the processor. The memory (404) is not limited to a volatile memory and/or a non-volatile memory. Further, the memory (404) can include one or more computer-readable storage media. The memory (404) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (404) stores the BSR (505) reports to be send to network (303) (i.e., network nodes) and also receive and stores the uplink grants received from the network (303).

The I/O interface (403) transmits the information between the memory and external peripheral devices. The peripheral devices are the input-output devices associated with the UE (401). The I/O interface (403) receives several information from the network. The I/O interface (403) is to transmit and receive data; however, the portion designated as the I/O interface (403) may contain additional resources, such as voltage translators, registers, impedances, and buffers. For Example: A keyboard and mouse provide Input to the computer are called input devices while a monitor and printer that provide output to the computer are called output devices. The I/O interface (403) transmits the BSR (505) and the MAC padding (506) to the network (303). Also, the I/O interface (403) receives the uplink grants from the network (303).

In an embodiment, the MAC entities (406) include the first MAC entity (401a), the second MAC entity (401b). Additionally, the UL grants are received from the network (303) based on the data volume requested in the BSR (505), and the UL transmission data is transmitted from the MAC entities (406) to the network (303) by the MAC padding (506) the UL transmission data based on the UL grants and the data volume. At least one of the first MAC entity (406a) or the second MAC entity (406b) determines a set of padded bits of the UL transmission data. Furthermore, the data volume is scaled to be requested in the subsequent BSR (505) at the at least one of the first MAC entity (406a) or the second MAC entity (406b) to optimize the UL grants from the network (303) and the MAC padding (506) at the UE (401).

MAC padding optimization controller (405) is an innovative hardwarethat is realized through the physical implementation of both analog and digital circuits, including logic gates, integrated circuits, microprocessors, microcontrollers, memory circuits, passive and active electronic components, as well as optical components. Hereinafter, in the disclosure, the MAC padding optimization controller (405) is described as a separate hardware component, but this is merely an example, and the corresponding controller may be implemented as a component of a processor or may be implemented as software.

The MAC padding optimization controller (405) is configured to transmit he BSR (505) to the network (303) from at least one of a first MAC entity (406a) or a second MAC entity (406b), wherein the BSR (505) comprises the data volume for transmission of the PDCP entity. Further, the MAC padding optimization controller (405) receive UL grants from the network (303) based on the data volume requested in the BSR (505). Also transmit the UL transmission data from at least one of the first MAC entity (406a) or the second MAC entity (406b) to the network (303) by MAC padding the UL transmission data based on the UL grants and the data volume. Moreover, determine a set of padded bits of the UL transmission data at the at least one of the first MAC entity (406a) or the second MAC entity (406b) and scale the data volume to be requested in the subsequent BSR (505) at the at least one of the first MAC entity (406a) or the second MAC entity (406b) to optimize the UL grants from the network (303) and the MAC padding (506) at the UE (401).

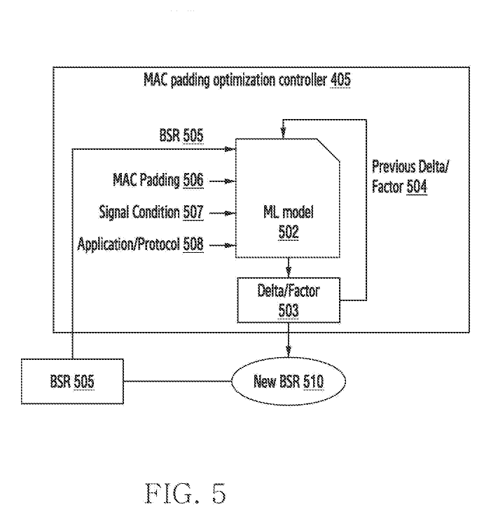

FIG. 5 illustrates a schematic view of the ML model (502) on the UE (401) side, according to an embodiment of the disclosure.

The ML model (502) is used to derive a "delta/factor" (503) to decrease/increase the UE's BSR reporting. The UE (401) may utilize the BSR (505), the MAC padding (506) volume, the network and signal condition (507), the application/protocol (508) in the ML model.

The delta/factor determine the up-scaling factor which includes inputting, by the UE (401), the plurality of parameters into the ML model (502). The plurality of parameters comprises the BSR (505). The BSR (505) comprises the data volume for transmission of the PDCP entity, set of padded bits of the UL transmission data, network signal conditions, a MAC padding pattern used by the UE (401), an up-scaling factor pattern, a reported BSR (505) index over each legs, a current PDCP status, a current RLC buffer status, a current network load associated with the first MAC entity (406a) and the second MAC entity (406b) , the bandwidth over each channels associated with the network (303), and a number of carrier components for each uplink channels to decide . Also obtaining, by the UE (401), the up-scaling factor by which the UL grants from the network (303) and the MAC padding at the UE (401) has to be optimized as an output from the ML model (502).

The delta/factor determining the down-scaling factor includes inputting, by the UE (401), the plurality of parameters into the ML model (502). The plurality of parameters comprises the BSR (505). The BSR (505) comprises the data volume for transmission of the PDCP entity, set of padded bits of the UL transmission data, network signal conditions, the MAC padding pattern used by the UE (401), an down-scaling factor pattern, a reported BSR (505) index over each legs, the current PDCP status, the current RLC buffer status, the current network load associated with the first MAC entity (406a) and the second MAC entity (406b), the bandwidth over each channels associated with the network (303), and the number of carrier components for each uplink channels to decide. Also obtaining, by the UE (401), the down-scaling factor by which the UL grants from the network (303) and the MAC padding (506) at the UE (401) has to be optimized as an output from the ML model (502).

The ML model (502) generates the delta factor (503) after taking the BSR (505), the MAC padding (506), the signal condition (507), the application (508) and also previous delta factor (504) to generate the delta factor (503) which helps in generating a new BSR (510).

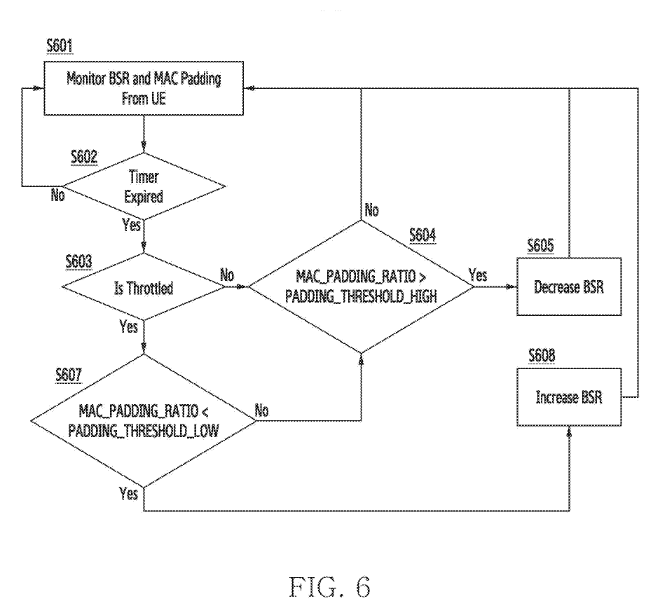

FIG. 6 is a flow diagram that illustrates a method for optimizing MAC padding at the UE, according to an embodiment of the disclosure.

At the operation S601, first monitoring the BSR (505) and MAC padding by the UE (401) is done.

At operation S602, the UE (401) checks if the timer has expired. If not, it sends back to check if monitoring BSR (505) and MAC padding (506) are still pending from the UE (401).

At the operation S603, the UE (401) determines whether the state of UE side MAC entity is throttled or not. For example, if the UE side MAC entity has reduced BSR reporting, the UE (401) determines that the state of UE side MAC entity is throttled. The UE (401) performs up-scaling the data volume to be requested in the subsequent BSR that optimizes the UL grants from the network (303) and the MAC padding at the UE (401), when the MAC padding ratio meets the MAC padding low criteria and the UE (401) meets the throttled criteria.

At operation S607, after meeting the throttled criteria, when the MAC padding ratio does not exceed low padding threshold PADDING_TRHRESHOLD_LOW), UE sends a request to increase the BSR (505). At operation S608, the BSR (505) is increased.

At operation S604, when the throttled criteria are not met, UE checks if the MAC padding ratio exceeds high padding threshold (PADDING_TRHRESHOLD_HIGH) or not. The MAC padding ratio refers to a ratio of a set of padded bits in previous UL transmission to throughput in the physical layer.

At operation S605, the BSR (505) is reduced. The MAC entity on the UE side employs a mechanism to decrease the BSR (505) of the UE (401) when it is transmitting excessive MAC padding (506) via the corresponding MAC entity. This is due to the UE (401) utilizing the remaining capacity to send uplink data.

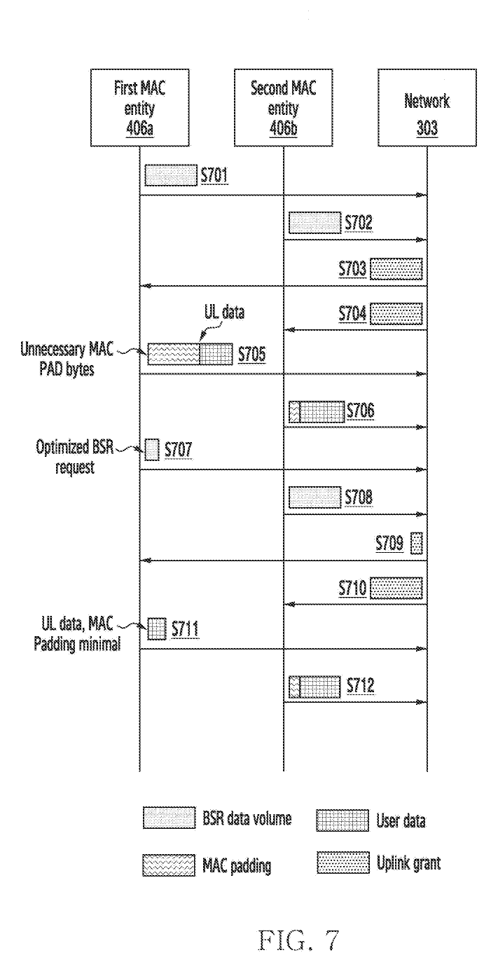

FIG. 7 is a sequence diagram that illustrates operations performed to optimize grant allocation and bringing the MAC Padding minimal for efficient usage of UL resources, according to an embodiment of the disclosure.

The UE (401) replicates the BSR (505) on both entities, indicating the PDCP data volume. At the network (303), network nodes allocate grants on both entities, while the UE (401) monitors the percentage of data sent as MAC padding (506). In the subsequent BSR (505), the UE (401) will downscale the data volume requested, and the network nodes will allocate a lesser grant according to the new BSR. Alternatively, the network nodes can also monitor the MAC padding (506) sent by the UE (401) and optimize grant allocations. The UE (401) continues to monitor padding and optimize the BSR (505) until the padding is within an acceptable threshold.

At operations S701 and S702, the initial MAC entity sends the BSR (505) request to the network (303). At operation S701, the UE (401) transmits the BSR (505) for the first MAC entity (406a) to MN. At operation S702 the UE (401) transmits the BSR (505) for the second MAC entity (406b) to SN. At operations S703 and S704, uplink grants are sent to the UE (401). At operation S703, the UE (401) receives uplink grant for the first MAC entity (406a) from the MN. At operations S704, the UE (401) receives uplink grant for the second MAC entity (406b) from the SN. At operations S705 and S706, superfluous MAC PAD bytes in UL data are transmitted from the first and second MAC entities (406) to the network (303). At operations S707 and S708, optimized BSR (505) requests are sent from the MAC entities of the UE (401) to the network (303). At operations S707, the UE (401) transmits optimized BSR (505) for the first MAC entity (406a) to the MN. At operations S708, the UE (401) transmits optimized BSR (505) for the second MAC entity (406b) to the SN. At operations S709 and S710, uplink grants are sent once again. Finally, at operations S711 and S712, UL data is sent from the respective entities to the network (303) with minimal MAC padding (506).

In an embodiment, this result in power consumption benefit as UL is cutting unnecessary uplink transmissions and efficient usage of UL resources. For example, the device at the network (303) may be referred to as network node.

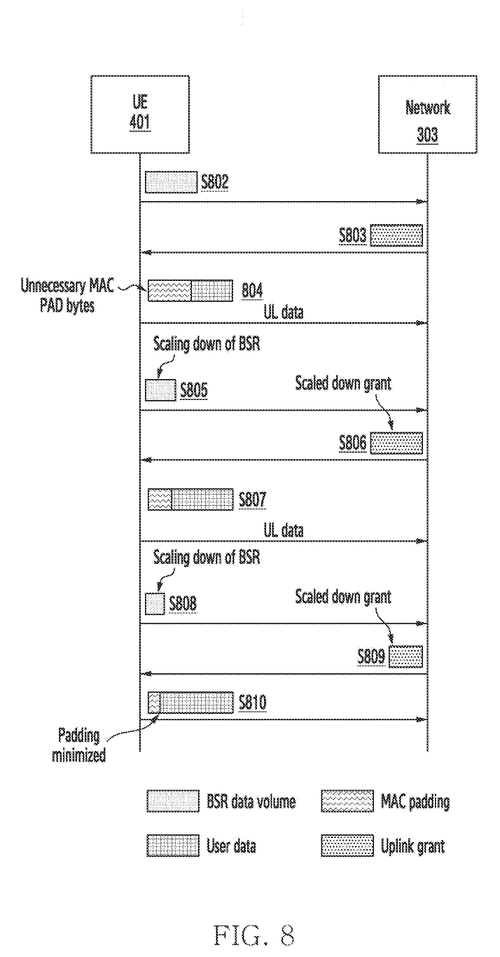

FIG. 8 is a sequence diagram that illustrates the MAC Padding optimization approach, according to an embodiment of the disclosure.

In an embodiment, a system and method are provided to prevent unnecessary UL transmissions caused by duplicate BSR (505) reporting, which results in excessive grant allocation by the network. Additionally, a mechanism is implemented to dynamically scale down MAC padding (506) by monitoring UL transmissions of the UE (401) and reducing the data volumes sent in the BSR (505) to the network (303). This mechanism also monitors data received from the UE (401) and reduces grant allocation by the network. A method is employed to determine the delta' factor, which is used to reduce the BSR (505) or grant allocations by the network in the event of the MAC padding issue

In operation S802, the UE (401) forwards the BSR (505) request to the network node at the network (303). Moving on to operation S803, the UE (401) receives UL grant from the network (303). The network node sends an UL grant to the UE (401). At operation S804, the UE (401) transmits UL data to the network apparatus (303), which may contain unnecessary MAC PAD bytes. Operation S805 involves scaling down the BSR (505) request to the network (303). In operation S806, the network node sends a scaled down UL grant to the UE (401). In operation S807, UL data is transmitted to the network. The BSR (505) request is scaled down again in operation S808, and sent to the network (303). At operation S809, the UE (401) receives an UL scaled down grant. Further, at operation S810, UL data with minimized padding is sent to the network (303).

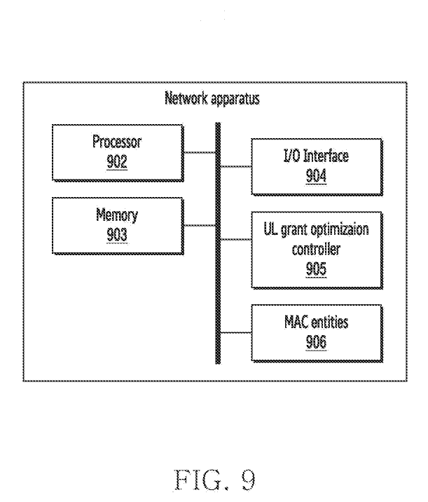

FIG. 9 illustrates a block diagram of the network apparatus for optimizing the MAC padding and UL grants in the wireless network, according to an embodiment of the disclosure.

The network apparatus may be refereed as network node at the network station. (303). The network apparatus includes the processor (902), memory (903), I/O interface (904), UL grant optimization controller (905) and MAC entities (906). The network apparatus can be at least one of the networks from the SIMs, or communication network to access services. For example, the UE (401) can include, but not limited to at least one of a mobile phone, a smart phone, tablets, laptops, or Internet of things (IoT) devices. Further, the processor of the network apparatus communicates with the memory (903), the I/O interface (904) and the UL grant optimization controller (905). The processor (902) is configured to execute instructions stored in the memory and to perform various processes. The processor (902) can include one or the plurality of processors, can be a general-purpose processor, such as the CPU, the AP, or the like, the graphics-only processing unit such as the GPU, the visual processing unit VPU and the AI dedicated processor such as the NPU. In the disclosure, network apparatus may be referred as the network node. In one implementation, the network node may be distributed unit (DU) connected to central unit (CU) or the central unit. In case of split bearer in dual connectivity (DC), two DUs are connected to the CU and the UE (401) can communicate with the two DUs. The CU and one DU acts MN and the CU and another DU acts SN. The CU may transmit UL grants thorough one of DUs to UE (401). The CU may receive UL data through at least one of the two DUs from the UE (401. In another implementation, the network node may be RAN node corresponding to one base The network node may be eNB or gNB. In case of split bearer in dual connectivity (DC), two base stations are connected the UE (401). The two base station includes the MN and the SN. For example, the gNB transmits UL data directly to the UE and transmits UL data through the eNB.

Further, the memory (903) of the UE (401) includes storage locations to be addressable through the processor. The memory contains information about the UE (401). The memory is not limited to a volatile memory and/or a non-volatile memory. Further, the memory can include one or more computer-readable storage media. The memory (903) can include non-volatile storage elements. For example, non-volatile storage elements can include magnetic hard discs, optical discs, floppy discs, flash memories, or forms of the EPROM or the EEPROM memories. The memory (903) can store the media streams such as audios stream, video streams, haptic feedbacks and the like. It stores the BSR and the MAC padding (506) from UE (401).

The Network apparatus comprise the processor (902), memory (903), I/O interface (904), UL grant optimization controller (905) and MAC entities (906).

The I/O interface (904) transmits the information between the memory and external peripheral devices. The peripheral devices are the input-output devices associated with the UE. The I/O interface (904) receives several information from the network. It comprises the first MAC entity (906a) and the second MAC entity (906b). I/O interface receives the BSR and the MAC padding from UE (401). Also, the I/O interface (904) transmit the uplink grants to the UE (401).

UL grant optimization controller (905) receives the BSR (505) by the UE (401) from at least one the first MAC entity (906a)) and the second MAC entity (906b)), wherein the BSR (505) comprises the data volume for transmission of the PDCP entity. Also, the UL grant optimization controller (905) transmits UL grants to the UE (401) based on the data volume requested in the BSR (505). The UL grant optimization controller (905) receives the UL transmission data from entities. The UL grant optimization controller (905) determines the set of padded bits of the UL transmission data from entities. Moreover, The UL grant optimization controller (905) scales the UL grants to optimize the MAC padding (506).

The UL grant optimization controller (905) is an innovative hardware that is realized through the physical implementation of both analog and digital circuits, including logic gates, integrated circuits, microprocessors, microcontrollers, memory circuits, passive and active electronic components, as well as optical components. Hereinafter, in the disclosure, the UL grant optimization controller (905) is described as a separate hardware component, but this is merely an example, and the corresponding controller may be implemented as a component of a processor or may be implemented as software.

MAC entities (906), comprises of the first MAC entity (906a) and/or the second MAC entity (906b).

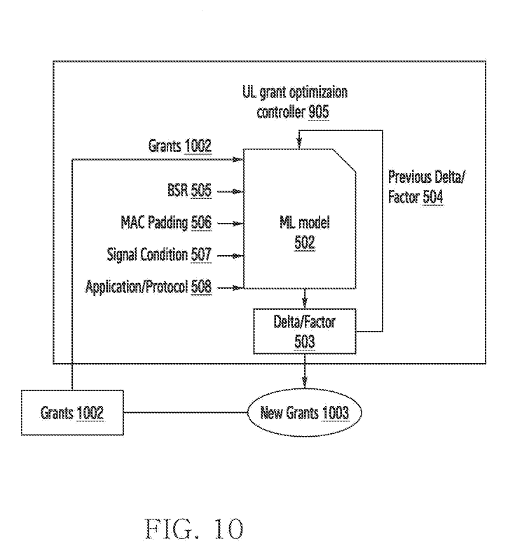

FIG. 10 is a schematic view of the ML model (502) designed for a network side, according to an embodiment of the disclosure.

In an embodiment, ML model (502) may be used to derive the delta/factor" (503) to decrease/increase the network grants (1002). The network apparatus (303) receives data requested (BSR (505) + Scheduling Request) by the UE (401), MAC Padding received from the UE (401) along with network condition. UL grant optimization controller (905) receives the BSR (505) by the UE (401) from at least one of the first MAC entity (906a) or the second MAC entity (906b), wherein the BSR (505) comprises the data volume for transmission of the PDCP entity.

ML model (502) generates the delta factor (503) after taking grants, MAC padding (506), signal condition (507), application (508) and also previous delta factor (504) to generate the Delta factor (503) which helps in generating the new grants (1003). The grants (1002) may be provided to UL grant optimization controller (905).

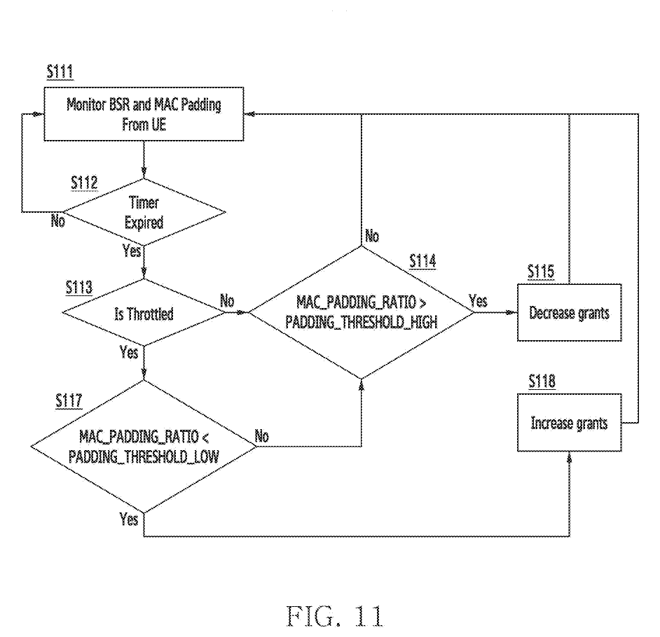

FIG. 11is a flow diagram that illustrates a method for optimizing UL grants at the network apparatus (e.g., network node at the network (303), according to an embodiment of the disclosure.

At the operation S111, first monitoring the BSR (505) and MAC padding from the UE (401) is done.

At operation 8112, the network node (e.g., MN or SN in DC) checks if the timer has expired. If not, it sends back to check if monitoring BSR (505) and MAC padding (506) are still pending from the UE (401).

At the operation S113, the network node checks if the throttled criteria is satisfied or not. For example, "Is throttled" indicates that NW side MAC Entity (906) has reduced UL Grant, because of proposed implementation.

At the operation S117, the network node checks if MAC_PADDING_RATIO does exceed low padding threshold (PADDING_THRESHHOLD_LOW)) or not. In case that MAC_PADDING_RATIO does not exceed low padding threshold (PADDING_THRESHHOLD_LOW)), the network node increases grants (S118).

At the operation S11, the network node checks if MAC_PADDING_RATIO exceed high padding threshold (PADDING_THRESHOLD_HIGH) or not. In case that MAC_PADDING_RATIO exceeds high padding threshold (PADDING_THRESHHOLD_HIGH)), uplink grant is reduced.

At operation S115, the network node decreases grant.

In an embodiment, when the network side MAC entity (906) implements mechanism to change UE's uplink grant in case the UE (401) is sending high MAC padding (506) over corresponding MAC entity (906) (as UE must be utilizing remaining leg to send uplink data).

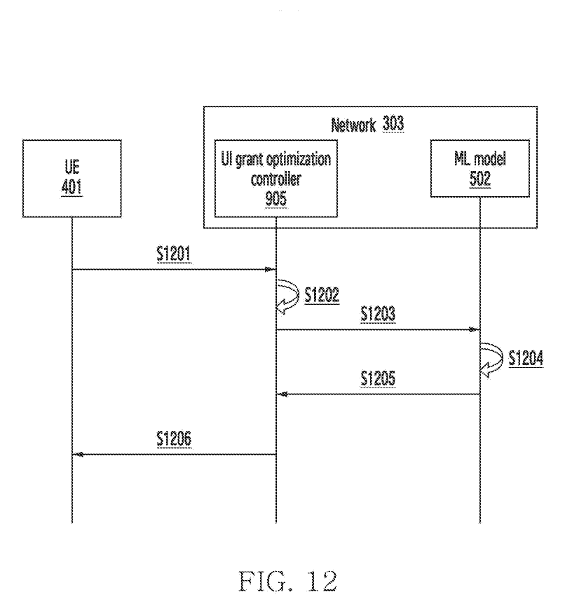

FIG. 12 is a sequence diagram that illustrates network operations for scheduling uplink grants, according to an embodiment of the disclosure.

In operation S1201, the UE (401) transmits a BSR (505) containing PDCP and RLC buffered data to the UL grant optimization controller (905) in the network apparatus (303). In operation S1202, the Network MAC entity computes grant for the corresponding BSR (505) index from the UE, taking into account the current network load, bandwidth, and other relevant factors. In operation S1203, the network MAC entity transmits the calculated uplink grant to the ML model. In operation S1204, the ML model (502) determines the delta/factor to either decrease or increase the calculated grants, based on parameters such as the reported BSR index, utilization of previous network-provided UL grants by the network (e.g., MAC padding), current signal conditions, current network load bandwidth, number of carrier components, and other relevant factors. In operation S1205, the ML model (502) outputs the derived delta/factor to either decrease or increase the calculated grants to the UL grant optimization controller (905). For implementation, the AI/ML module in the network apparatus (303) sends the derived delta/factor to either decrease or increase the calculated grants. Further, at operation S1206, the network apparatus (303) sends uplink grants to the UE (401). In other words, the network schedules uplink grants accordingly.

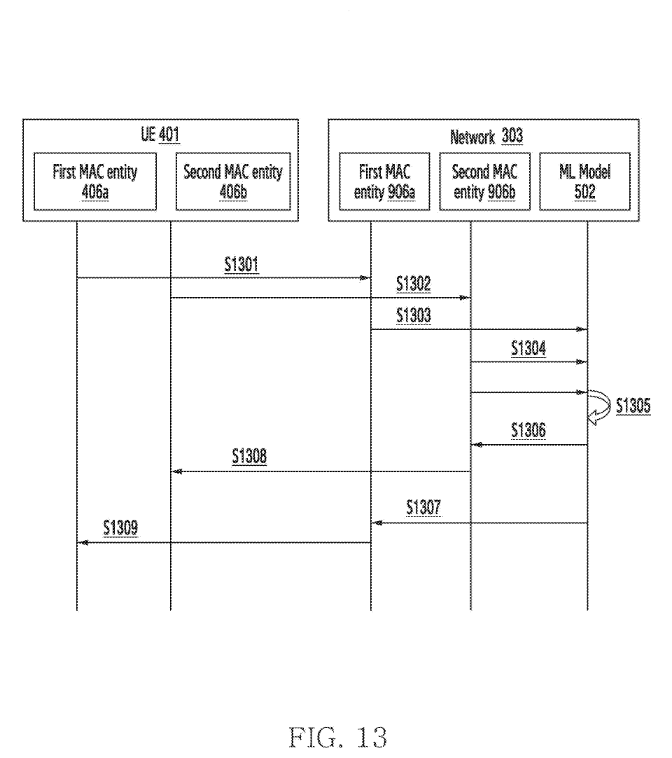

FIG. 13 is a sequence diagram that illustrates the signaling flow of the MAC entities and NR grant scheduling in the ENDC scenario, according to an embodiment of the disclosure. The UE (401) includes entities.

At operation S1301, the first MAC entity (406a) of the UE transmits a BSR (505) containing buffered PDCP and RLC data. Similarly, at operation S1302, the second MAC entity (406b) of the UE sends the BSR (505) with the same content to the second MAC entity (906b). At operation S1303, the first MAC entity (906a) on the network side requests input from the ML model (502). The second MAC entity (906b) on the network side then sends the calculated uplink grant to the ML model (502) at operation S1304.

Further, at operation S1305, the ML model (502) derives aggregated uplink grants and calculates an uplink grant assignment strategy based on various parameters such as at least one of the reported BSR index over all channels, utilization of previous network-provided UL grants over both channels, current signal conditions for respective channels, current network load for respective channels, bandwidth of respective channels, or the number of carrier components of respective channels.

The ML model (502) then sends the uplink grant allocation information to the second MAC entity (906b) in the network apparatus (303) at operation S1306, and to the first MAC entity (301) at operation S1307. The second MAC entity (302) schedules uplink grants accordingly at operation S1308, followed by the first MAC entity (406a) at operation S1309.

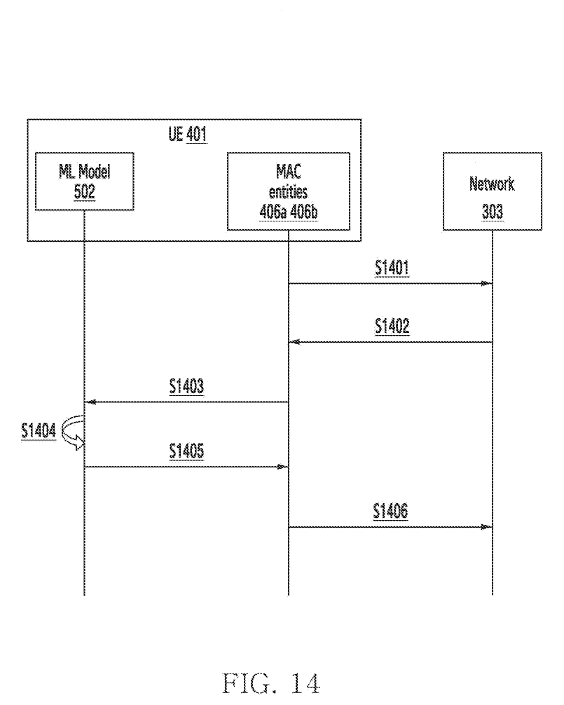

FIG. 14 is a sequence diagram that illustrates operations performed by the UE (401) for sending the BSR report, according to an embodiment of the disclosure.

At operation S1401, the UE (401) sending BSR (505) Report consists of the PDCP and the RLC buffered data to the network apparatus (303).

In operation 81402, the network apparatus (303) schedules uplink grants to the MAC entities (406a, 406b), comprising the first MAC entity (406a) and the second MAC entity (406b). In operation S1403, the UE MAC entities transmit the scheduled uplink grants to the ML model (502).

At operation S1404, the ML Model (502) calculates the delta factor for adjusting the BSR (505) index in individual entities. This is done by taking into account various parameters such as at least one of the utilization of previous network-provided UL grants, MAC padding, reported BSR (505) index over each entity, current PDCP and RLC buffer status, current signal conditions over each leg, current network load over each leg, bandwidth over each channel, or the number of carrier components for each uplink channel. These factors are then used to make informed decisions

At the S1405 stage, the ML Model (502) transmits a derived delta/factor to adjust the BSR (505) index by decreasing or increasing it. In a particular embodiment, at the S1406 stage, the UE (401) sends the BSR (505) as appropriate.

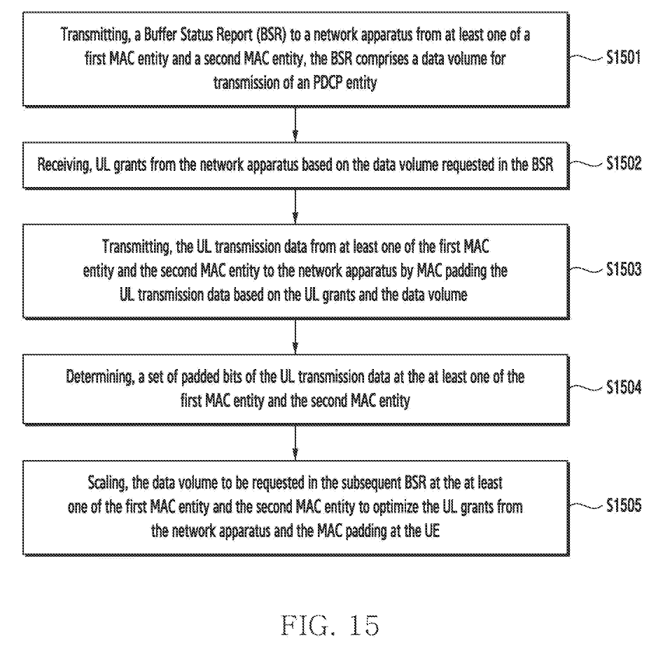

FIG. 15 is a flow chart that illustrates a method for optimizing the MAC padding and UL grants in the wireless network system, according to an embodiment of the disclosure.

At operation S1501, the UE transmit, the BSR to the network apparatus from at least one of the first MAC entity or the second MAC entity and the BSR comprises a data volume for transmission of the PDCP entity.

At operation S1502, the UE (401) receives UL grants from the network apparatus based on the requested data volume in the BSR (505). At operation S1503, the UE (401) transmits the UL transmission data from either the first MAC entity (406a) or the second MAC entity (406b) to the network apparatus (303) by MAC padding (506) the UL transmission data based on the UL grants and the data volume. At operation S1504, the set of padded bits of the UL transmission data is determined at either the first MAC entity (406a) or the second MAC entity (406b). Further, at operation S1505, the data volume to be requested in the subsequent BSR is scaled at either the first MAC entity (406a) or the second MAC entity (406b) to optimize the UL grants from the network apparatus (303) and the MAC padding (506) at the UE (401).

In embodiments, a method for optimizing a medium access control (MAC) padding and UL grants in a wireless network system, comprises transmitting, by a UE, a buffer status report (BSR) to a network apparatus from at least one of a first MAC entity or a second MAC entity, the BSR comprises a data volume for transmission of an PDCP entity; receiving, by the UE, UL grants from the network apparatus based on the data volume requested in the BSR; transmitting, by the UE, the UL transmission data from at least one of the first MAC entity or the second MAC entity to the network apparatus by MAC padding the UL transmission data based on the UL grants and the data volume; determining, by the UE, a set of padded bits of the UL transmission data at the at least one of the first MAC entity or the second MAC entity; scaling, by the UE, the data volume to be requested in the subsequent BSR at the at least one of the first MAC entity or the second MAC entity to optimize the UL grants from the network apparatus and the MAC padding at the UE.

For example, the method comprises transmitting, by the UE, the scaled data volume from at least one of the first MAC entity or the second MAC entity to the network apparatus, the subsequent BSR comprises the scaled data volume; receiving, by the UE, UL grant from the network apparatus based on the scaled data volume requested in the subsequent BSR; and transmitting, by the UE, the UL transmission data from at least one of the first MAC entity or the second MAC entity to the network apparatus by MAC padding the set of data bits of the UL transmission data based on the UL grants and the scaled data volume.

For example, the PDCP entity being simultaneously associated with at least one the first MAC entity and the second MAC entity for a radio bearer.

For example, scaling, by at least one of the first MAC entity or the second comprises determining, by the UE, a MAC padding ratio based on the set of padded bits of the UL transmission data and a throughput data from a physical layer of the UE; determining, by the UE, whether the MAC padding ratio meets a MAC padding high criteria or the MAC padding low criteria and the UE meets a throttled criterion; and performing, by the UE, one of down-scaling the data volume to be requested in the subsequent BSR that optimizes the UL grants from the network apparatus and the MAC padding at the UE, when the MAC padding ratio meets the MAC padding high criteria and the UE does not meet the throttled criteria; and up-scaling the data volume to be requested in the subsequent BSR that optimizes the UL grants from the network apparatus and the MAC padding at the UE, when thew MAC padding ratio meets the MAC padding low criteria and the UE meets the throttled criteria.

For example, the throttled criteria indicate a state in which the network apparatus has reduced a level of UL grant meeting a predefined UL grant threshold.

For example, the up-scaling the data volume to be requested in the entity and the second MAC entity of the UE has reduced a level of BSR reporting meeting a predefined BSR reporting threshold.

For example, the determining the up-scaling volume to be requested in the subsequent BSR comprises determining an up-scaling factor by which the UL grants from the network apparatus and the MAC padding at the UE has to be optimized based on plurality of parameters using a machine learning (ML) model; and up-scaling the data volume to be requested in the subsequent BSR by the up-scaling factor.

For example, the determining the up-scaling factor comprises inputting, by the UE, the plurality of parameters into a machine learning (ML) model. The plurality of parameters comprises the BSR comprises a data volume for transmission of an PDCP entity, set of padded bits of the UL transmission data, network signal conditions, a MAC padding pattern used by the UE, an up-scaling factor pattern, a reported BSR index over each legs, a current PDCP status, a current RLC buffer status, a current network load associated with the first MAC entity and the second MAC entity, a bandwidth over each channels associated with the network apparatus, and a number of carrier components for each uplink channels to decide. The determining the up- scaling factor comprises obtaining, by the UE, the up-scaling factor by which the UL grants from the network apparatus and the MAC padding at the UE has to be optimized as an output from the ML model.

For example, the down-scaling the data volume to be requested in the subsequent BSR comprises determining a down-scaling factor by which the UL grants from the network apparatus and the MAC padding at the UE has to be optimized based on a plurality of parameters; and down-scaling the data volume to be requested in the subsequent BSR by the down-scaling factor.

For example, the determining the down-scaling factor comprises inputting, by the UE, the plurality of parameters into a machine learning (ML) model, the plurality of parameters comprises the BSR comprises a data volume for transmission of an PDCP entity, set of padded bits of the UL transmission data, network signal conditions, a MAC padding pattern used by the UE, an down-scaling factor pattern, a reported BSR index over each legs, a current PDCP status, a current RLC buffer status, a current network load associated with the first MAC entity and the second MAC entity a bandwidth over each channels associated with the network apparatus, and a number of carrier components for each uplink channels to decide; and obtaining, by the UE, the down-scaling factor by which the UL grants from the network apparatus and the MAC at the UE has to be optimized as an output from the ML model.

In embodiments, a method for optimizing a Medium Access Control (MAC) padding and UL grants in a wireless network system is provided. The method, comprises receiving, by a network apparatus, a BSR by a UE from at least one a first MAC entity and a second MAC entity. The BSR comprises a data volume for transmission of an PDCP entity. The method comprises transmitting, by the network apparatus, UL grants to the UE based on the data volume requested in the BSR; receiving, by the network apparatus, the UL transmission data from at least one of the first MAC entity or the second MAC entity of the UE by MAC padding the UL transmission data based on the UL grants and the data volume; determining, by the network apparatus a set of padded bits of the UL transmission data at the at least one of the first MAC entity or the second MAC entity; and scaling, by the network apparatus, the UL grants to optimize the MAC padding received in subsequent UL transmissions from the first MAC entity and the second MAC entity of the UE.

For example, the method, comprises receiving, by the network apparatus, the scaled data volume from at least one of the first MAC entity or the second MAC entity of the UE, the subsequent BSR comprises the scaled data volume; transmitting, by the network apparatus, UL grant to the UE based on the scaled data volume requested in the subsequent BSR; and receiving, by the network apparatus, the UL transmission data from at least one of the first MAC entity or the second MAC entity of the UE by MAC padding the set of data bits of the UL transmission data based on the UL grants and the scaled data volume.

For example, the PDCP entity being simultaneously associated with at least one the first MAC entity and the second MAC entity for a radio bearer.

For example, scaling, by at least one of the first MAC entity or the second MAC entity of the UE, the UL grants allocated to the UE to optimize the MAC padding at the UE, comprises determining, by the network apparatus, a MAC padding ratio based on the set of padded bits of the UL transmission data and a throughput data from a physical layer of the UE; determining, by the network apparatus, whether the MAC padding ratio meets a MAC padding high criteria or the MAC padding low criteria and the UE meets a throttled criterion; and performing, by the network apparatus, one of down-scaling the UL grants to optimize the data volume and the MAC padding received in the subsequent UL transmissions from the first MAC entity and the second MAC entity of the UE, when the MAC padding ratio meets the MAC padding high criteria and the network apparatus does meet the throttled criteria; and up-scaling the UL grants to optimize the MAC padding received in the subsequent UL transmissions from the first MAC entity and the second MAC entity of the UE, when the MAC padding ratio meets the MAC padding low criteria and the network apparatus meets the throttled criteria.

For example, the throttled criteria indicate a state in which the network apparatus has reduced a level of UL grant meeting a predefined UL grant threshold.

For example, the up-scaling the UL grant allocation to the UE comprises determining an up-scaling factor by which the UL grants from the network apparatus has to be optimized based on a plurality of parameters using a machine learning (ML) model; and up-scaling the UL grants by the up-scaling factor.

For example, the determining the up-scaling factor comprises inputting, by the network apparatus, the plurality of parameters into a machine learning (ML) model, the plurality of parameters comprises the BSR (505) comprises a data volume for transmission of an PDCP entity, set of padded bits of the UL transmission data, network signal conditions, a MAC padding pattern used by the UE, an up-scaling factor pattern, a reported BSR index over each legs, a current PDCP status, a current RLC buffer status, a current network load associated with the first MAC entity and the second MAC entity, a bandwidth over each channels associated with the network apparatus, and a number of carrier components for each uplink channels to decide; and obtaining, by the network apparatus, the up-scaling factor by which the UL grants from the network apparatus has to be optimized as an output from the ML mode.

For example, the down-scaling UL grant allocation to the UE comprises determining a down-scaling factor by which the UL grants from the network apparatus has to be optimized based on a plurality of parameters; and down-scaling the UL grants by the down-scaling factor.

For example, the determining the down-scaling factor comprises inputting, by the network apparatus, the plurality of parameters into a machine learning (ML) model. The plurality of parameters comprises the BSR comprises a data volume for transmission of an PDCP entity, set of padded bits of the UL transmission data, network signal conditions, a MAC padding pattern used by the UE, an down-scaling factor pattern, a reported BSR index over each legs, a current PDCP status, a current RLC buffer status, a current network load associated with the first MAC entity and the second MAC entity, a bandwidth over each channels associated with the network apparatus, and a number of carrier components for each uplink channels to decide. The determining the down-scaling factor comprises obtaining, by the network apparatus, the down-scaling factor by which the UL grants from the network apparatus has to be optimized as an output from the ML model.

In embodiments, a user equipment (UE) for optimizing a MAC padding and UL grants in a wireless network system is provided. The UE comprises memory comprising information about a network apparatus; a plurality of entities comprising a first MAC entity, a second MAC entity, a PDCP entity; a processor communicatively coupled to the memory; and a MAC padding optimization controller, configured to transmit a BSR to a network apparatus from at least one of a first MAC entity or a second MAC entity, the BSR comprises a data volume for transmission of an PDCP entity; receive UL grants from the network apparatus based on the data volume requested in the BSR; transmit the UL transmission data from at least one of the first MAC entity or the second MAC entity to the network apparatus by MAC padding the UL transmission data based on the UL grants and the data volume; determine a set of padded bits of the UL transmission data at the at least one of the first MAC entity or the second MAC entity; and scale the data volume to be requested in the subsequent BSR at the at least one of the first MAC entity or the second MAC entity to optimize the UL grants from the network apparatus and the MAC padding at the UE.

For example, the UE is configured to transmit the scaled data volume from at least one of the first MAC entity or the second MAC entity to the network apparatus, the subsequent BSR comprises the scaled data volume; receive UL grant from the network apparatus based on the scaled data volume requested in the subsequent BSR; and transmit the UL transmission data from at least one of the first MAC entity or the second MAC entity to the network apparatus by MAC padding the set of data bits of the UL transmission data based on the UL grants and the scaled data volume.

For example, the PDCP entity being simultaneously associated with at least one the first MAC entity and the second MAC entity for a radio bearer.

For example, scaling, by at least one of the first MAC entity or the second MAC entity of the UE, the data volume to be requested in the subsequent BSR to optimize the UL grants from the network apparatus and the MAC padding at the UE comprises determining, by the UE, a MAC padding ratio based on the set of padded bits. of the UL transmission data and a throughput data from a physical layer of the UE; determining, by the UE, whether the MAC padding ratio meets a MAC padding high criteria or the MAC padding low criteria and the UE meets a throttled criterion; and performing, by the UE, one of down-scaling the data volume to be requested in the subsequent BSR that optimizes the UL grants from the network apparatus and the MAC padding at the UE, when the MAC padding ratio meets the MAC padding high criteria and the UE does not meet the throttled criteria; and up-scaling the data volume to be requested in the subsequent BSR that optimizes the UL grants from the network apparatus and the MAC padding at the UE, when the MAC padding ratio meets the MAC padding low criteria and the UE meets the throttled criteria.

For example, the throttled criteria indicate a state in which the first MAC entity and the second MAC entity of the UE has reduced a level of BSR reporting meeting a predefined BSR reporting threshold.

For example, the up-scaling the data volume to be requested in the subsequent BSR comprises determining an up-scaling factor by which the UL grants from the network apparatus and the MAC padding at the UE has to be optimized based on a plurality of parameters using a machine learning (ML) model; and up-scaling the data volume to be requested in the subsequent BSR by the up-scaling factor.

For example, the determining the up-scaling factor comprises inputting, by the UE, the plurality of parameters into a machine learning (ML) model The plurality of parameters comprises the BSR comprises a data volume for transmission of an PDCP entity, set of padded bits of the UL transmission data, network signal conditions, a MAC padding pattern used by the UE, an up-scaling factor pattern, a reported BSR index over each legs, a current PDCP status, a current RLC buffer status, a current network load associated with the first MAC entity and the second MAC entity, a bandwidth over each channels associated with the network apparatus, and a number of carrier components for each uplink channels to decide. The determining the up-scaling factor comprises obtaining, by the UE, the up-scaling factor by which the UL grants from the network apparatus and the MAC padding at the UE has to be optimized as an output from the ML mode.

For example, the down-scaling the data volume to be requested in the subsequent BSR comprises determining a down-scaling factor by which the UL grants from the network apparatus and the MAC padding at the UE has to be optimized based on a plurality of parameters; and down-scaling the data volume to be requested in the subsequent BSR by the down-scaling factor.

For example, the determining the down-scaling factor comprises inputting, by the UE, the plurality of parameters into a machine learning (ML) model, the plurality of parameters comprises the BSR comprises a data volume for transmission of an PDCP entity, set of padded bits of the UL transmission data, network signal conditions, a MAC padding pattern used by the UE, an down-scaling factor pattern, a reported BSR index over each legs, a current PDCP status, a current RLC buffer status, a current network load associated with the first MAC entity and the second MAC entity, a bandwidth over each channels associated with the network apparatus, and a number of carrier components for each uplink channels to decide; and obtaining, by the UE, the down-scaling factor by which the UL grants from the network apparatus and the MAC padding at the UE has to be optimized as an output from the ML model.

In embodiments, a network apparatus for optimizing a MAC padding and UL grants in a wireless network system is provided. The network apparatus comprises: memory comprising information about a UE; a plurality of entities comprising a first MAC entity, a second MAC entity; a processor communicatively coupled to the memory; and a UL grant optimization controller, configured to receive a BSR by a UE from at least one a first MAC entity and a second MAC entity, the BSR comprises a data volume for transmission of an PDCP entity; transmit UL grants to the UE based on the data volume requested in the BSR; receive the UL transmission data from at least one of the first MAC entity or the second MAC entity of the UE by MAC padding the UL transmission data based on the UL grants and the data volume; determine a set of padded bits of the UL transmission data at the at least one of the first MAC entity or the second MAC entity; scale the UL grants to optimize the MAC padding received in subsequent UL transmissions from the first MAC entity and the second MAC entity of the UE.

For example, the network apparatus is configured to receive the scaled

data volume from at least one of the first MAC entity or the second MAC entity of the UE. The subsequent BSR comprises the scaled data volume. The network apparatus is configured to transmit UL grant to the UE based on the scaled data volume requested in the subsequent BSR. The network apparatus is configured to receive the UL transmission data from at least one of the first MAC entity or the second MAC entity of the UE by MAC padding the set of data bits of the UL transmission data based on the UL grants and the scaled data volume.

For example, the PDCP entity is simultaneously associated with at least one the first MAC entity and the second MAC entity for a radio bearer.

For example, the scaling, by at least one of the first MAC entity or the second MAC entity of the UE, the UL grants allocated to the UE to optimize the MAC padding at the UE comprises determining, by the network apparatus, a MAC padding ratio based on the set of padded bits of the UL transmission data and a throughput data from a physical layer of the UE; determining, by the network apparatus, whether the MAC padding ratio meets a MAC padding high criteria or the MAC padding low criteria and the UE meets a throttled criterion; and performing, by the network apparatus, one of down-scaling the UL grants to optimize the data volume and the MAC padding received in the subsequent UL transmissions from the first MAC entity and the second MAC entity of the UE, when the MAC padding ratio meets the MAC padding high criteria and the network apparatus does meet the throttled criteria; and up-scaling the UL grants to optimize the MAC padding received in the subsequent UL transmissions from the first MAC entity and the second MAC entity of the UE, when the MAC padding ratio meets the MAC padding low criteria and the network apparatus meets the throttled criteria.

For example, the throttled criteria indicate a state in which the network apparatus has reduced a level of UL grant meeting a predefined UL grant threshold.

For example, the up-scaling the UL grant allocation to the UE comprises determining an up-scaling factor by which the UL grants from the network apparatus has to be optimized based on a plurality of parameters using a machine learning (ML) model; and up-scaling the UL grants by the up-scaling factor.

For example, the determining the up-scaling factor comprises inputting, by the network apparatus, the plurality of parameters into a machine learning (ML) model. The plurality of parameters comprises the BSR comprises a data volume for transmission of an PDCP entity, set of padded bits of the UL transmission data, network signal conditions, a MAC padding pattern used by the UE, an up-scaling factor pattern, a reported BSR index over each legs, a current PDCP status, a current RLC buffer status, a current network load associated with the first MAC entity and the second MAC entity, a bandwidth over each channels associated with the network apparatus, and a number of carrier components for each uplink channels to decide. The determining the up- scaling factor comprises obtaining, by the network apparatus, the up-scaling factor by which the UL grants from the network apparatus has to be optimized as an output from the ML mode.

For example, the down-scaling UL grant allocation to the UE comprises determining a down-scaling factor by which the UL grants from the network apparatus has to be optimized based on a plurality of parameters; and down-scaling the UL grants by the down-scaling factor.

For example, the determining the down-scaling factor comprises inputting, by the network apparatus, the plurality of parameters into a machine learning (ML) model. The plurality of parameters comprises the BSR comprises a data volume for transmission of an PDCP entity, set of padded bits of the UL transmission data, network signal conditions, a MAC padding pattern used by the UE, an down-scaling factor pattern, a reported BSR index over each legs, a current PDCP status, a current RLC buffer status, a current network load associated with the first MAC entity and the second MAC entity, a bandwidth over each channels associated with the network apparatus, and a number of carrier components for each uplink channels to decide. The determining the down-scaling factor comprises obtaining, by the network apparatus, the down-scaling factor by which the UL grants from the network apparatus has to be optimized as an output from the ML model.

In embodiments, a method performed by a user equipment (UE) in a wireless network system is provided. The method comprises transmitting a first buffer status report (BSR) to a first network node, wherein the first BSR comprises a data volume for transmission of a packet data convergence protocol (PDCP) entity; transmitting a second BSR to a second network node, wherein the second BSR comprises the data volume for transmission of the PDCP entity; transmitting first uplink (UL) transmission data with a first set of padded bits to the first network node based on UL grants from the first network node; transmitting second UL transmission data with a second set of padding bits to the first network node based on UL grants from the first network node; scaling the data volume to be requested in a first subsequent BSR to the first network node based on a first MAC padding ratio indicating a ratio of the first set of padded bits of the first UL transmission data over an UL throughput to the first network node; and scaling the data volume to be requested in a second subsequent BSR to the second network node based on a second MAC padding ratio indicating a ratio of the second set of padded bits of the UL transmission data over an UL throughput to the second network node.

For example, the method comprises transmitting, by the UE, first subsequent BSR to the first network node, wherein the first subsequent BSR comprises first scaled data volume; receiving, by the UE, first UL grants from the first network node based on the first scaled data volume requested in the first subsequent BSR; and transmitting, by the UE, UL transmission data based on the first UL grants and the first scaled data volume.

For example, the PDCP entity is associated with a first RLC entity and a second RLC entity in a split bearer. The first RLC entity is linked to a first MAC entity. The second RLC entity is linked to a second MAC entity.

For example, the scaling of the data volume to be requested in the first subsequent BSR comprises determining whether a throttled criteria is satisfied or not; and in case that the throttled criteria is not satisfied and the first MAC padding ratio exceeds a high padding threshold, down-scaling the data volume to be requested in the first subsequent BSR; and in case that the throttled criteria is satisfied and the first MAC padding ratio is smaller than a low padding threshold, up-scaling the data volume to be requested in the first subsequent BSR.

For example, the throttled criteria comprises a condition that a buffer size level of the first BSR and a buffer size level of the first BSR are lower than a predefined level.

For example, the data volume to be requested in the first subsequent BSR or the data volume to be requested in the first subsequent BSR is scaled based on a scaling factor. The scaling factor is determined based on at least one of a plurality of parameters using a machine learning (ML) model.

For example, the plurality of parameters includes at least two of the data volume for transmission of the PDCP entity, the first set of padded bits of the first UL transmission data, the second set of padded bits of the second UL transmission data, network signal condition for the first network node, network signal condition for the second network node, a MAC padding pattern used by the UE, an up-scaling factor pattern, a reported BSR index over each legs, a current PDCP status, a current RLC buffer status for a first RLC entity, a current RLC buffer status for a second RLC entity, a current network load, a bandwidth over channel associated with the first network node, a bandwidth over channel associated with the second network node, or a number of carrier components for each uplink channels.

For example, the UE is configured in a dual connectivity with the first network node and the second network node. A total amount of data volume indicated by the first subsequent BSR and data volume of the second subsequent BSR is smaller than a total amount of data volume indicated by the first BSR and data volume of the second BSR. The total amount of the data volume indicated by the first BSR and the data volume of the second BSR is greater than a data split threshold configured by a radio resource control (RRC) signaling, and The total amount of the data volume indicated by the subsequent first BSR and the data volume of the subsequent second BSR is greater than the data split threshold configured by the RRC signaling.

In embodiments, a method performed by a network node is provided. The method comprises receiving, from a user equipment (UE), a buffer status report (BSR), wherein the BSR comprises a data volume for transmission of a packet data convergence protocol (PDCP) entity for split bearer; transmitting, to the UE, uplink (UL) grants based on the data volume requested in the BSR; receiving, from the UE, UL transmission data with a set of padding bits in accordance with the UL grants; and scaling the UL grants based on a first MAC padding ratio indicating a ratio of the set of padded bits of the UL transmission data over an UL throughput from the UE to the network node.

For example, wherein the scaling the UL grants comprises determining whether a throttled criteria is satisfied or not; in case that the throttled criteria is not satisfied and the first MAC padding ratio exceeds a high padding threshold, down- scaling the UL grants to be provided to the UE; and in case that the throttled criteria is satisfied and the first MAC padding ratio is smaller than a low padding threshold, up- scaling the UL grants to be provided to the UE.

For example, the throttled criteria comprises a condition that resources of the UL grant are lower than a predefined amount.

For example, the UL grants to be provided to the UE is scaled based on a scaling factor. The scaling factor is determined based on at least one of a plurality of parameters using a machine learning (ML) model.

For example, the plurality of parameters includes at least two of the data volume for transmission of the PDCP entity, the first set of padded bits of the first UL transmission data, the second set of padded bits of the second UL transmission data, network signal condition for the first network node, network signal condition for the second network node, a MAC padding pattern used by the UE, an up-scaling factor pattern, a reported BSR index over each legs, a current PDCP status, a current RLC buffer status for a first RLC entity, a current RLC buffer status for a second RLC entity, a current network load, a bandwidth over channel associated with the first network node, a bandwidth over channel associated with the second network node, or a number of carrier components for each uplink channels.

In embodiments, a user equipment (UE) in a wireless network system is provided. The UE comprises at least one transceiver; at least one processor; and memory storing instructions that, when executed by the at least one processor cause the UE to transmit, through the at least one transceiver, a first buffer status report (BSR) to a first network node, wherein the first BSR comprises a data volume for transmission of a packet data convergence protocol (PDCP) entity; transmit, through the at least one transceiver, a second BSR to a second network node, wherein the second BSR comprises the data volume for transmission of the PDCP entity; transmit, through the at least one transceiver, first UL transmission data with a first set of padded bits to the first network node based on UL grants from the first network node; transmit, through the at least one transceiver, second UL transmission data with a second set of padding bits to the first network node based on UL grants from the first network node; scaling the data volume to be requested in a first subsequent BSR to the first network node based on a first MAC padding ratio indicating a ratio of the first set of padded bits of the first UL transmission data over an UL throughput to the first network node; and scaling the data volume to be requested in a second subsequent BSR to the second network node based on a second MAC padding ratio indicating a ratio of the second set of padded bits of the UL transmission data over an UL throughput to the second network node.

In embodiments, a network node in a wireless network system is provided. The network node comprises at least one transceiver; at least one processor; and memory storing instructions that, when executed by the at least one processor cause the UE to receive, from a user equipment (UE), a buffer status report (BSR), wherein the BSR comprises a data volume for transmission of a packet data convergence protocol (PDCP) entity for split bearer; transmit, to the UE, uplink (UL) grants based on the data volume requested in the BSR; receive, from the UE, UL transmission data with a set of padding bits in accordance with the UL grants; and scale the UL grants based on a first MAC padding ratio indicating a ratio of the set of padded bits of the UL transmission data over an UL throughput from the UE to the network node.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless network system, the method comprising:
transmitting, to a first network node, a first buffer status report (BSR), the first BSR including a first data volume for transmission of a packet data convergence protocol (PDCP) entity;
transmitting, to a second network node, a second BSR, the second BSR including a second data volume for transmission of the PDCP entity;
transmitting, to the first network node, first uplink (UL) transmission data with a first set of padded bits, based on first UL grants from the first network node;
transmitting, to the second network node, second UL transmission data with a second set of padding bits, based on second UL grants from the second network node;
scaling the first data volume to a first scaled data volume to be requested in a first subsequent BSR to the first network node, based on a first medium access control (MAC) padding ratio of the first set of padded bits of the first UL transmission data over a first UL throughput to the first network node; and
scaling the second data volume to a second scaled data volume to be requested in a second subsequent BSR to the second network node, based on a second MAC padding ratio of the second set of padded bits of the second UL transmission data over a second UL throughput to the second network node.

2. The method of claim 1, further comprising:
transmitting, to the first network node, the first subsequent BSR to the first network node, the first subsequent BSR including the first scaled data volume;
receiving, from the first network node, first subsequent UL grants, based on the first scaled data volume requested in the first subsequent BSR; and
transmitting, to the first network node, first subsequent UL transmission data, based on the first subsequent UL grants.

3. The method of claim 1,
wherein the PDCP entity is associated with a first radio link control (RLC) entity and a second RLC entity in a split bearer,
wherein the first RLC entity is linked to a first MAC entity, and
wherein the second RLC entity is linked to a second MAC entity.

4. The method of claim 1, wherein the scaling of the first data volume to the first scaled data volume to be requested in the first subsequent BSR comprises:
determining whether a throttled criteria is satisfied or not;
in case that the throttled criteria is not satisfied and the first MAC padding ratio is greater than a high padding threshold, down-scaling the first data volume to the first scaled data volume to be requested in the first subsequent BSR; and
in case that the throttled criteria is satisfied and the first MAC padding ratio is less than a low padding threshold, up-scaling the first data volume to the first scaled data volume to be requested in the first subsequent BSR.

5. The method of claim 4, wherein the throttled criteria includes a condition that a first buffer size level of the first BSR and a second buffer size level of the second BSR are lower than a predefined level.

6. The method of claim 1,
wherein the first data volume is scaled to the first scaled data volume to be requested in the first subsequent BSR or the second data volume is scaled to the second scaled data volume to be requested in the second subsequent BSR, based on a scaling factor, and
wherein the scaling factor is determined based on at least one of a plurality of parameters using a machine learning (ML) model.

7. The method of claim 6, wherein the plurality of parameters includes at least two of:
the first data volume for transmission of the PDCP entity,
the first data volume for transmission of the PDCP entity,
the first set of padded bits of the first UL transmission data,
the second set of padded bits of the second UL transmission data,
first network signal condition for the first network node,
second network signal condition for the second network node,
a MAC padding pattern used by the UE,
an up-scaling factor pattern,
a reported BSR index over each leg,
a current PDCP status,
a current first radio link control (RLC) buffer status for a first RLC entity,
a current second RLC buffer status for a second RLC entity,
a current network load,
a first bandwidth over channel associated with the first network node,
a second bandwidth over channel associated with the second network node, or a number of carrier components for each uplink channel.

8. The method of claim 1,
wherein the UE is configured in a dual connectivity with the first network node and the second network node,
wherein a second total amount of data volume indicated by the first subsequent BSR and the second subsequent BSR is less than a first total amount of data volume indicated by the first BSR and the second BSR,
wherein the first total amount of the data volume indicated by the first BSR and the second BSR is greater than a data split threshold configured by a radio resource control (RRC) signaling, and
wherein the second total amount of the data volume indicated by the first subsequent BSR and the second subsequent BSR is greater than the data split threshold configured by the RRC signaling.

9. A user equipment (UE) in a wireless network system, the UE comprising:
at least one transceiver;
at least one processor; and
memory storing instructions that, when executed by the at least one processor individually or collectively, cause the UE to: transmit, to a first network node through the at least one transceiver, a first buffer status report (BSR), the first BSR including a first data volume for transmission of a packet data convergence protocol (PDCP) entity, transmit, to a second network node through the at least one transceiver, a second BSR, the second BSR including a second data volume for transmission of the PDCP entity, transmit, to the first network node through the at least one transceiver,
first uplink (UL) transmission data with a first set of padded bits, based on first UL grants from the first network node, transmit, to the second network node through the at least one transceiver,
second UL transmission data with a second set of padding bits, based on second UL grants from the second network node, scale the first data volume to a first scaled data volume to be requested in a first subsequent BSR to the first network node, based on a first medium access control (MAC) padding ratio of the first set of padded bits of the first UL transmission data over a first UL throughput to the first network node, and scale the second data volume to a second scaled data volume to be requested in a second subsequent BSR to the second network node, based on a second MAC padding ratio of the second set of padded bits of the second UL transmission data over a second UL throughput to the second network node.

10. The UE of claim 9, wherein the memory stores further instructions that, when executed by the at least one processor individually or collectively, cause the UE to:
transmit, to the first network node through the at least one transceiver, the first subsequent BSR to the first network node, the first subsequent BSR including the first scaled data volume,
receive, from the first network node through the at least one transceiver, first subsequent UL grants, based on the first scaled data volume requested in the first subsequent BSR, and
transmit, to the first network node through the at least one transceiver, first subsequent UL transmission data, based on the first subsequent UL grants.

11. The UE of claim 9,
wherein the PDCP entity is associated with a first radio link control (RLC) entity and a second RLC entity in a split bearer,
wherein the first RLC entity is linked to a first MAC entity, and
wherein the second RLC entity is linked to a second MAC entity.

12. The UE of claim 9, wherein the memory stores further instructions, to scale the first data volume to the first scaled data volume to be requested in the first subsequent BSR, that, when executed by the at least one processor individually or collectively, cause the UE to:
determine whether a throttled criteria is satisfied or not,
in case that the throttled criteria is not satisfied and the first MAC padding ratio is greater than a high padding threshold, down-scale the first data volume to the first scaled data volume to be requested in the first subsequent BSR, and
in case that the throttled criteria is satisfied and the first MAC padding ratio is less than a low padding threshold, up-scale the first data volume to the first scaled data volume to be requested in the first subsequent BSR.

13. The UE of claim 12, wherein the throttled criteria includes a condition that a first buffer size level of the first BSR and a second buffer size level of the second BSR are lower than a predefined level.

14. The UE of claim 9,
wherein the first data volume is scaled to the first scaled data volume to be requested in the first subsequent BSR or the second data volume is scaled to the second scaled data volume to be requested in the second subsequent BSR, based on a scaling factor, and
wherein the scaling factor is determined based on at least one of a plurality of parameters using a machine learning (ML) model.

15. The UE of claim 14, wherein the plurality of parameters includes at least two of:
the first data volume for transmission of the PDCP entity, the first data volume for transmission of the PDCP entity,
the first set of padded bits of the first UL transmission data,
the second set of padded bits of the second UL transmission data,
first network signal condition for the first network node,
second network signal condition for the second network node,
a MAC padding pattern used by the UE,
an up-scaling factor pattern,
a reported BSR index over each leg,
a current PDCP status,
a current first radio link control (RLC) buffer status for a first RLC entity,
a current second RLC buffer status for a second RLC entity,
a current network load,
a first bandwidth over channel associated with the first network node,
a second bandwidth over channel associated with the second network node, or a number of carrier components for each uplink channel.

16. The UE of claim 9,
wherein the UE is configured in a dual connectivity with the first network node and the second network node,
wherein a second total amount of data volume indicated by the first subsequent BSR and the second subsequent BSR is less than a first total amount of data volume indicated by the first BSR and the second BSR,
wherein the first total amount of the data volume indicated by the first BSR and the second BSR is greater than a data split threshold configured by a radio resource control (RRC) signaling, and
wherein the second total amount of the data volume indicated by the first subsequent BSR and the second subsequent BSR is greater than the data split threshold configured by the RRC signaling.

17. A network node in a wireless network system, the network node comprising:
at least one transceiver;
at least one processor; and
memory storing instructions that, when executed by the at least one processor individually or collectively, cause the network node to: receive, from a user equipment (UE) through the at least one transceiver,
a buffer status report (BSR), the BSR including a data volume for transmission of a packet data convergence protocol (PDCP) entity for split bearer, transmit, to the UE through the at least one transceiver, uplink (UL) grants based on the data volume requested in the BSR, receive, from the UE through the at least one transceiver, UL transmission data with a set of padding bits in accordance with the UL grants, and scale the UL grants to scaled UL grants to be provided to the UE, based on a first medium access control (MAC) padding ratio of the set of padded bits of the UL transmission data over an UL throughput from the UE to the network node.

18. The network node of claim 17, wherein the memory stores further instructions, to scale the UL grants to the scaled UL grants to be provided to the UE, that, when executed by the at least one processor individually or collectively, cause the network node to:
determine whether a throttled criteria is satisfied or not,
in case that the throttled criteria is not satisfied and the MAC padding ratio is greater than a high padding threshold, down-scale the UL grants to the scaled UL grants to be provided to the UE, and
in case that the throttled criteria is satisfied and the MAC padding ratio is less than a low padding threshold, up-scale the UL grants to the scaled UL grants to be provided to the UE.

19. The network node of claim 18, wherein the throttled criteria includes a condition that resources of the UL grant are lower than a predefined amount.

20. The network node of claim 17,
wherein the UL grants is scaled to the scaled UL grants to be provided to the UE, based on a scaling factor, and
wherein the scaling factor is determined based on at least one of a plurality of parameters using a machine learning (ML) model.
